(19) United States
(12) Patent Application Publication
(10) Pub. No.: US 2023/0080580 A1
(43) Pub. Date: Mar. 16, 2023

(54) LIQUID CRYSTAL POLARIZATION HOLOGRAM ELEMENT FOR REDUCING RAINBOW EFFECTS

(71) Applicant: Meta Platforms Technologies, LLC, Menlo Park, CA (US)

(72) Inventors: Xiayu FENG, Kirkland, WA (US); Yun-Han LEE, Redmond, WA (US); Babak AMIRSOLAIMANI, Redmond, WA (US); Mengfei WANG, Woodinville, WA (US); Junren WANG, Kirkland, WA (US); Lu LU, Kirkland, WA (US)

(21) Appl. No.: 17/866,463

(22) Filed: Jul. 15, 2022

Related U.S. Application Data
(60) Provisional application No. 63/243,733, filed on Sep. 14, 2021.

(51) Int. Cl. G02B 5/30; G02B 5/18; G02B 5/20

(52) U.S. Cl. CPC G02B 5/3016; G02B 5/1814; G02B 5/203

(57) ABSTRACT

A device includes a diffraction element and an optical filter stacked with the diffraction element. The optical filter is configured to forwardly deflect a light from a real-world environment incident onto the optical filter, at an incidence angle greater than or equal to a predetermined angle, toward the diffraction element. The diffraction element is configured to substantially transmit the light forwardly deflected by the optical filter.

### CROSS REFERENCE TO RELATED APPLICATION

This application claims the benefit of priority to U.S. Provisional Application No. 63/243,733, filed on Sep. 14, 2021. The content of the above-mentioned application is incorporated herein by reference in its entirety.

### TECHNICAL FIELD

The present disclosure relates generally to optical devices and, more specifically, to liquid crystal polarization hologram elements for reducing rainbow effects.

### BACKGROUND

Liquid crystal polarization holograms (“LCPHs”) refer to the intersection of liquid crystal devices and polarization holograms. Liquid crystal displays (“LCDs”), having grown to a trillion dollar industry over the past decades, are the most successful example of liquid crystal devices. The LCD industry has made tremendous investments to scale manufacturing, from the low end G2.5 manufacturing line to the high end G10.5+ to meet the market demands for displays. However, the LCD industry has recently faced competition from organic light-emitting diodes (“OLED”), e-paper and other emerging display technologies, that has flattened the growth rate of LCD industry and has rendered significant early generation capacity redundant. This provides an opportunity to repurpose the LCD idle capacity and existing supply chain to manufacture novel LC optical devices characterized by their polarization holograms.

LCPHs have features such as small thickness (˜1 um), light weight, compactness, large aperture, high efficiency, simple fabrication, etc. Thus, LCPHs have gained increasing interests in optical device and system applications, e.g., near-eye displays (“NEDs”), head-up displays (“HUDs”), head-mounted displays (“HMDs”), smart phones, laptops, televisions, or vehicles, etc. For example, LCPHs may be used for addressing accommodation-vergence conflict, enabling thin and highly efficient eye-tracking and depth sensing in space constrained optical systems, developing optical combiners for image formation, correcting chromatic aberrations for image resolution enhancement of refractive optical elements in compact optical systems, and improving the efficiency and reducing the size of optical systems.

### SUMMARY OF THE DISCLOSURE

Consistent with an aspect of the present disclosure, a device is provided. The device includes a diffraction element and an optical filter stacked with the diffraction element. The optical filter is configured to forwardly deflect a light from a real-world environment incident onto the optical filter, at an incidence angle greater than or equal to a predetermined angle, toward the diffraction element. The diffraction element is configured to transmit the light forwardly deflected by the optical filter.

Consistent with another aspect of the present disclosure, a device is provided. The device includes a polarization hologram having a first surface and a second surface. The device includes a retardation film having a third surface and a fourth surface. The device includes a substrate disposed between the polarization hologram and the retardation film. The polarization hologram is configured to refract a first light incident onto the first surface toward the substate and the retardation film. The first light propagates through the substate into the retardation film from the third surface. The retardation film is configured to reflect the first light at the fourth surface as a second light propagating toward the third surface, and convert the second light into a third light having a predetermined polarization while transmitting the second light. The third light propagates through the substrate into the polarization hologram from the second surface. The polarization hologram is configured to transmit the third light out of the polarization hologram from the first surface.

Consistent with another aspect of the present disclosure, an optical element is provided. The optical element includes a birefringent medium layer having an optic axis configured with respective spatially varying orientations in both of an in-plane direction and an out-of-plane direction. The birefringent medium layer includes optically anisotropic molecules. Orientations of directors of the optically anisotropic molecules spatially varying in the out-of-plane direction with a varying vertical pitch. A vertical pitch of the birefringent medium layer varies in the out-of-plane direction, the vertical pitch being a distance along the out-of-plane direction over which the orientations of directors of the optically anisotropic molecules vary by a predetermined angle.

Other aspects of the present disclosure can be understood by those skilled in the art in light of the description, the claims, and the drawings of the present disclosure. The foregoing general description and the following detailed description are exemplary and explanatory only and are not restrictive of the claims.

### BRIEF DESCRIPTION OF THE DRAWINGS

The following drawings are provided for illustrative purposes according to various disclosed embodiments and are not intended to limit the scope of the present disclosure. In the drawings:

FIG. 1A illustrates a schematic three-dimensional (“3D”) view of a polarization volume hologram (“PVH”) element, according to an embodiment of the present disclosure;

FIG. 1B illustrates a portion of a schematic 3D orientational pattern of optically anisotropic molecules included in a PVH element, according to an embodiment of the present disclosure;

FIG. 1C illustrates a portion of a schematic 3D orientational pattern of optically anisotropic molecules included in a PVH element, according to another embodiment of the present disclosure;

FIG. 1D illustrates a portion of a schematic 3D orientational pattern of optically anisotropic molecules included in a PVH element, according to another embodiment of the present disclosure;

FIG. 1E illustrates a portion of a schematic in-plane orientational pattern of optically anisotropic molecules included in the PVH element shown in FIGS. 1B-1D, according to an embodiment of the present disclosure;

FIG. 1F illustrates a portion of a schematic in-plane orientational pattern of optically anisotropic molecules included in the PVH element shown in FIGS. 1B-1D, according to another embodiment of the present disclosure;

FIG. 1G illustrates a portion of a schematic in-plane orientational pattern of optically anisotropic molecules included in the PVH element shown in FIGS. 1B-1D, according to another embodiment of the present disclosure;

FIG. 2A illustrates diffraction orders of a transmissive PVH element, according to an embodiment of the present disclosure;

FIG. 2B illustrates diffraction orders of a reflective PVH element, according to an embodiment of the present disclosure;

FIG. 3A illustrates a schematic diagram showing a rainbow effect caused by a PVH element;

FIGS. 3B and 3C illustrate schematic diagrams of optical devices for suppressing the rainbow effect shown in FIG. 3A, according to various embodiments of the present disclosure;

FIG. 4A illustrates a schematic diagram showing a rainbow effect caused by a PVH element;

FIG. 4B illustrates a plot of Fresnel transmittance and reflectance of a light versus incidence angle of the light at an air-glass interface;

FIG. 4C illustrates a schematic diagram of an optical device for suppressing the rainbow effect shown in FIG. 4A, according to an embodiment of the present disclosure;

FIG. 5A illustrates a schematic diagram showing a rainbow effect caused by a PVH element;

FIGS. 5B and 5C illustrate schematic diagrams of optical devices for suppressing the rainbow effect shown in FIG. 5A, according to various embodiments of the present disclosure;

FIGS. 6A and 6B illustrate schematic diagrams of optical devices for suppressing the rainbow effect shown in FIG. 5A, according to various embodiments of the present disclosure;

FIGS. 7A-7F illustrate schematic diagrams of optical devices for suppressing a rainbow effect, according to various embodiments of the present disclosure;

FIG. 8 illustrates a schematic diagram of a light guide display system, according to an embodiment of the present disclosure;

FIG. 9A illustrates a schematic diagram of a near-eye display (“NED”), according to an embodiment of the present disclosure; and

FIG. 9B illustrates a schematic cross sectional view of half of the NED shown in FIG. 9A, according to an embodiment of the present disclosure.

### DETAILED DESCRIPTION

Embodiments consistent with the present disclosure will be described with reference to the accompanying drawings, which are merely examples for illustrative purposes and are not intended to limit the scope of the present disclosure. Wherever possible, the same reference numbers are used throughout the drawings to refer to the same or similar parts, and a detailed description thereof may be omitted.

Further, in the present disclosure, the disclosed embodiments and the features of the disclosed embodiments may be combined. The described embodiments are some but not all of the embodiments of the present disclosure. Based on the disclosed embodiments, persons of ordinary skill in the art may derive other embodiments consistent with the present disclosure. For example, modifications, adaptations, substitutions, additions, or other variations may be made based on the disclosed embodiments. Such variations of the disclosed embodiments are still within the scope of the present disclosure. Accordingly, the present disclosure is not limited to the disclosed embodiments. Instead, the scope of the present disclosure is defined by the appended claims.

As used herein, the terms “couple,” “coupled,” “coupling,” or the like may encompass an optical coupling, a mechanical coupling, an electrical coupling, an electromagnetic coupling, or any combination thereof. An “optical coupling” between two optical elements refers to a configuration in which the two optical elements are arranged in an optical series, and a light output from one optical element may be directly or indirectly received by the other optical element. An optical series refers to optical positioning of a plurality of optical elements in a light path, such that a light output from one optical element may be transmitted, reflected, diffracted, converted, modified, or otherwise processed or manipulated by one or more of other optical elements. In some embodiments, the sequence in which the plurality of optical elements are arranged may or may not affect an overall output of the plurality of optical elements. A coupling may be a direct coupling or an indirect coupling (e.g., coupling through an intermediate element).

The phrase “at least one of A or B” may encompass all combinations of A and B, such as A only, B only, or A and B. Likewise, the phrase “at least one of A, B, or C” may encompass all combinations of A, B, and C, such as A only, B only, C only, A and B, A and C, B and C, or A and B and C. The phrase “A and/or B” may be interpreted in a manner similar to that of the phrase “at least one of A or B.” For example, the phrase “A and/or B” may encompass all combinations of A and B, such as A only, B only, or A and B. Likewise, the phrase “A, B, and/or C” has a meaning similar to that of the phrase “at least one of A, B, or C.” For example, the phrase “A, B, and/or C” may encompass all combinations of A, B, and C, such as A only, B only, C only, A and B, A and C, B and C, or A and B and C.

When a first element is described as “attached,” “provided,” “formed,” “affixed,” “mounted,” “secured,” “connected,” “bonded,” “recorded,” or “disposed,” to, on, at, or at least partially in a second element, the first element may be “attached,” “provided,” “formed,” “affixed,” “mounted,” “secured,” “connected,” “bonded,” “recorded,” or “disposed,” to, on, at, or at least partially in the second element using any suitable mechanical or non-mechanical manner, such as depositing, coating, etching, bonding, gluing, screwing, press-fitting, snap-fitting, clamping, etc. In addition, the first element may be in direct contact with the second element, or there may be an intermediate element between the first element and the second element. The first element may be disposed at any suitable side of the second element, such as left, right, front, back, top, or bottom.

When the first element is shown or described as being disposed or arranged “on” the second element, term “on” is merely used to indicate an example relative orientation between the first element and the second element. The description may be based on a reference coordinate system shown in a figure, or may be based on a current view or example configuration shown in a figure. For example, when a view shown in a figure is described, the first element may be described as being disposed “on” the second element. It is understood that the term “on” may not necessarily imply that the first element is over the second element in the vertical, gravitational direction. For example, when the assembly of the first element and the second element is turned 180 degrees, the first element may be “under” the second element (or the second element may be “on” the first element). Thus, it is understood that when a figure shows that the first element is “on” the second element, the configuration is merely an illustrative example. The first element may be disposed or arranged at any suitable orientation relative to the second element (e.g., over or above the second element, below or under the second element, left to the second element, right to the second element, behind the second element, in front of the second element, etc.).

When the first element is described as being disposed “on” the second element, the first element may be directly or indirectly disposed on the second element. The first element being directly disposed on the second element indicates that no additional element is disposed between the first element and the second element. The first element being indirectly disposed on the second element indicates that one or more additional elements are disposed between the first element and the second element.

The term “processor” used herein may encompass any suitable processor, such as a central processing unit (“CPU”), a graphics processing unit (“GPU”), an application-specific integrated circuit (“ASIC”), a programmable logic device (“PLD”), or any combination thereof. Other processors not listed above may also be used. A processor may be implemented as software, hardware, firmware, or any combination thereof.

The term “controller” may encompass any suitable electrical circuit, software, or processor configured to generate a control signal for controlling a device, a circuit, an optical element, etc. A “controller” may be implemented as software, hardware, firmware, or any combination thereof. For example, a controller may include a processor, or may be included as a part of a processor.

The term “non-transitory computer-readable medium” may encompass any suitable medium for storing, transferring, communicating, broadcasting, or transmitting data, signal, or information. For example, the non-transitory computer-readable medium may include a memory, a hard disk, a magnetic disk, an optical disk, a tape, etc. The memory may include a read-only memory (“ROM”), a random-access memory (“RAM”), a flash memory, etc.

The term “communicatively coupled” or “communicatively connected” indicates that related items are coupled or connected through an electrical and/or electromagnetic coupling or connection, such as a wired or wireless communication connection, channel, or network.

The wavelength ranges, spectra, or bands mentioned in the present disclosure are for illustrative purposes. The disclosed optical device, system, element, assembly, and method may be applied to a visible wavelength range, as well as other wavelength ranges, such as an ultraviolet (“UV”) wavelength range, an infrared (“IR”) wavelength range, or a combination thereof.

The term “film,” “layer,” “coating,” or “plate” may include rigid or flexible, self-supporting or free-standing film, layer, coating, or plate, which may be disposed on a supporting substrate or between substrates. The terms “film,” “layer,” “coating,” and “plate” may be interchangeable. The term “film plane” refers to a plane in the film, layer, coating, or plate that is perpendicular to the thickness direction or a normal of a surface of the film, layer, coating, or plate. The film plane may be a plane in the volume of the film, layer, coating, or plate, or may be a surface plane of the film, layer, coating, or plate. The term “in-plane” as in, e.g., “in-plane orientation,” “in-plane direction,” “in-plane pitch,” etc., means that the orientation, direction, or pitch is within the film plane. The term “out-of-plane” as in, e.g., “out-of-plane direction,” “out-of-plane orientation,” or “out-of-plane pitch” etc., means that the orientation, direction, or pitch is not within a film plane (i.e., non-parallel with a film plane). For example, the direction, orientation, or pitch may be along a line that is perpendicular to a film plane, or that forms an acute or obtuse angle with respect to the film plane. For example, an “in-plane” direction or orientation may refer to a direction or orientation within a surface plane, an “out-of-plane” direction or orientation may refer to a thickness direction or orientation non-parallel with (e.g., perpendicular to) the surface plane. In some embodiments, an “out-of-plane” direction or orientation may form an acute or right angle with respect to the film plane.

The term “orthogonal” as used in “orthogonal polarizations” or the term “orthogonally” as used in “orthogonally polarized” means that an inner product of two vectors representing the two polarizations is substantially zero. For example, two lights with orthogonal polarizations or two orthogonally polarized lights may be two linearly polarized lights with polarizations in two orthogonal directions (e.g., an x-axis direction and a y-axis direction in a Cartesian coordinate system) or two circularly polarized lights with opposite handednesses (e.g., a left-handed circularly polarized light and a right-handed circularly polarized light).

Liquid crystal polarization hologram (“LCPT”) elements may be implemented in various portable or wearable devices or systems, such as near-eye displays (“NEDs”), head-up displays (“HUDs”), or head-mounted displays (“HMADs”), smart phones, laptops, tablets, etc. NEDs, HUDs, and HMDs have been used to realize virtual reality (“VR”), augmented reality (“AR”), or mixed reality (“MR”). NEDs, HUDs, or HMDs for AR and/or MR applications may display a virtual image overlapping with real-world images or see-through images. For example, LCPH elements may be implemented in a display module (e.g., light guide display system) as coupling elements that couple an image light into and/or out of a light guide, implemented in a display module (e.g., a holographic near eye display, a retinal projection eyewear, or a wedged waveguide display) as beam steering devices that enables pupil steered AR, VR, and/or MR display systems, or implemented in an eye tracking module as infrared (“IR”) light deflecting elements that deflect IR lights reflected by eyes toward an optical sensor, etc. Pupil-expansion light guide display systems or assemblies are promising designs for NEDs, HUDs, or HMDs, which can potentially offer sun/eye-glasses form factors, a moderately large field of view (“FOV”), a high transmittance, and a large eye-box. In addition, NEDs, HUDs, or HMDs for VR, AR and/or MR applications may provide an eye tracking function that monitors the eyes of a user and/or the region surrounding the eyes of a user. By monitoring the eyes and/or the surrounding region, the NEDs, HUDs, or HMDs can determine a gaze direction of the user, which can be used for improving display quality, performance, and user experience, and addressing vergence-accommodation conflict. Further, by monitoring the eyes and/or the surrounding region, the NEDs, HUDs, or HMDs can estimate the psychological state and/or changes in the psychological state of the user, as well as physical characteristics of the user.

LCPH elements included in NEDs, HUDs, and HMDs for AR and/or MR applications may diffract, refract, and/or reflect a visible polychromatic light coming from a real-world environment, causing a multicolored glare in a see-through view, especially when a user wearing the NED, HUD, or HMD looks at a bright light source from certain angles. Such a see-through artifact is referred to as a “rainbow effect,” which may degrade the image quality of the see-through view. The rainbow effect may result from a light dispersion caused by the LCPH elements. For example, an LCPH element may spatially separate, e.g., via diffraction, reflection, and/or refraction, an incident polychromatic light (e.g., a white light from the real-world environment) into constituent wavelength components. Each wavelength of the incident light spectrum may be directed to a different direction, producing a rainbow of colors under a white light illumination. To reduce the rainbow effect, conventional dimming elements have been used to dim the light from the real-world environment that is incident onto display windows at different incidence angles, thereby dimming an overall light intensity of the dispersion. However, the brightness of the desirable see-through image may also be reduced correspondingly.

The present disclosure provides various mechanisms to reduce the rainbow effect caused by an LCPH element. Among LCPH elements, liquid crystal (“LC”) based Pancharatnam-Berry phase (“PBP”) elements and LC-based polarization volume hologram (“PVH”) elements have been extensively studied. A PBP element may modulate a circularly polarized light based on a phase profile provided through a geometric phase. A PBP element may split a linearly polarized light or an unpolarized light into two circularly polarized lights with opposite handednesses and symmetric deflecting directions. A PVH element may modulate a circularly polarized light based on Bragg diffraction. Orientations of LC molecules in the PBP element and the PVH element may exhibit rotations in three dimensions, and may have similar in-plane orientational patterns. PBP element and the PVH element have features such as flatness, compactness, high efficiency, high aperture ratio, absence of on-axis aberrations, flexible design, simple fabrication, and low cost, etc.

For illustrative purposes, PVH elements are used as examples of LCPH elements to explain various mechanisms and design principles to reduce the rainbow effect caused by the LCPH elements. The PVH elements described herein may be fabricated based on various methods, such as holographic interference, laser direct writing, ink-jet printing, and various other forms of lithography. Thus, a “hologram” described herein is not limited to creation by holographic interference, or “holography”. The mechanisms and design principles disclosed herein for reducing the rainbow effect caused by the PVH elements may also be applicable to reducing the rainbow effect caused by other LCPH elements, such as LC-based PBP elements, or to reducing the rainbow effect caused by other polarization hologram elements fabricated based on birefringent photo-refractive holographic materials other than LCs.

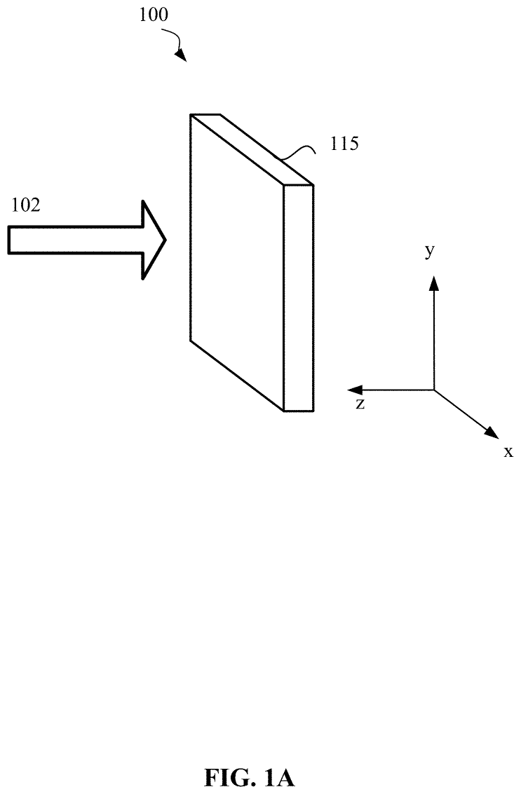

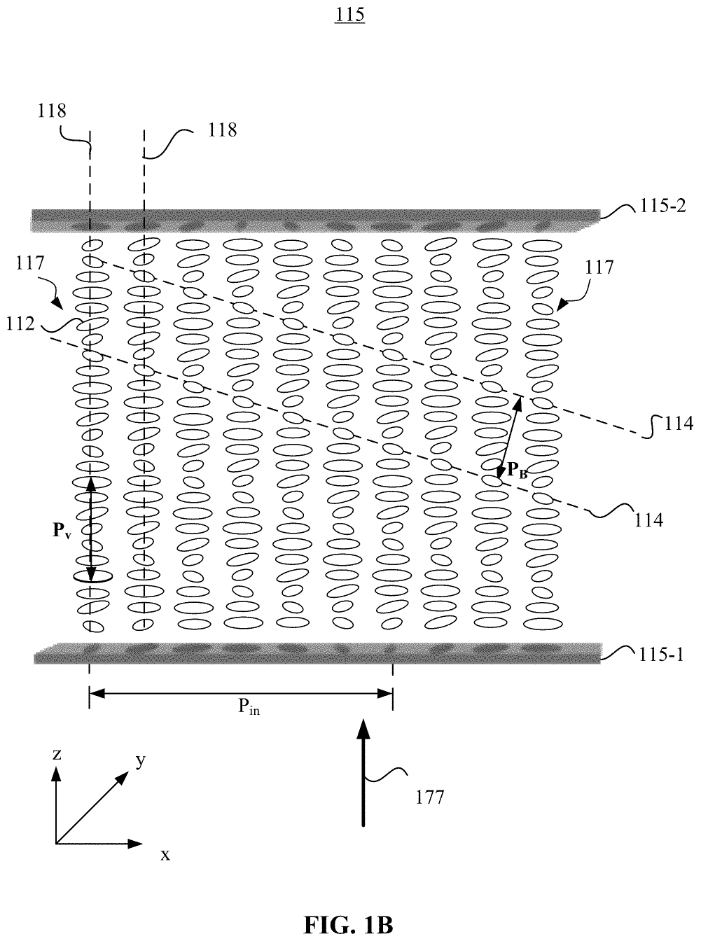

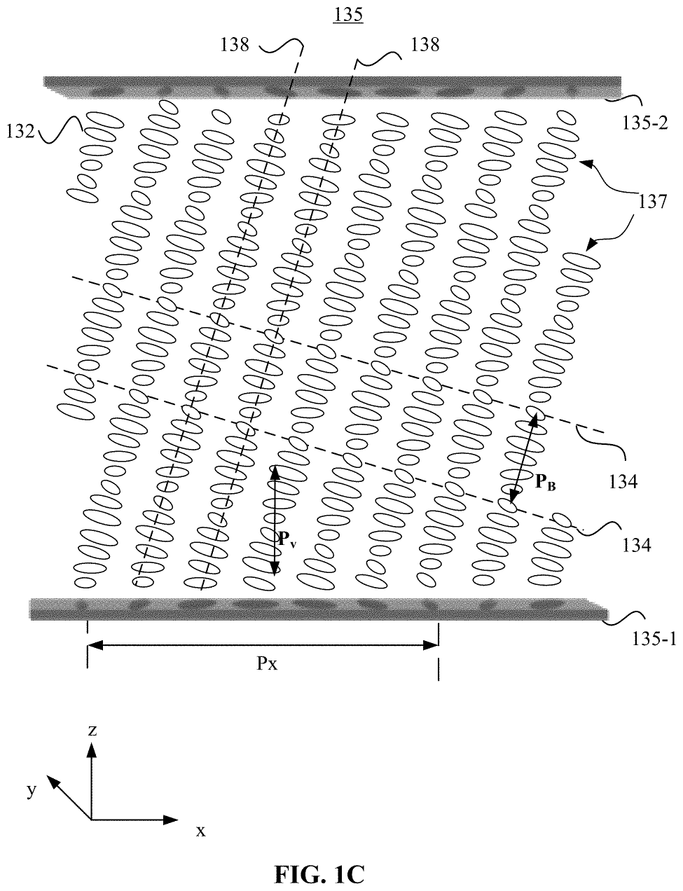

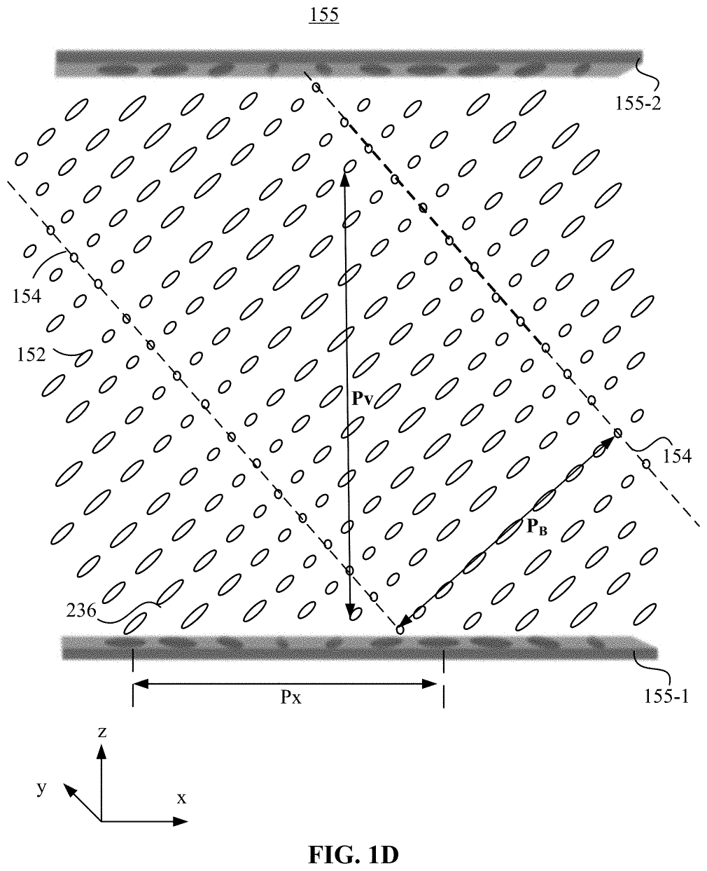

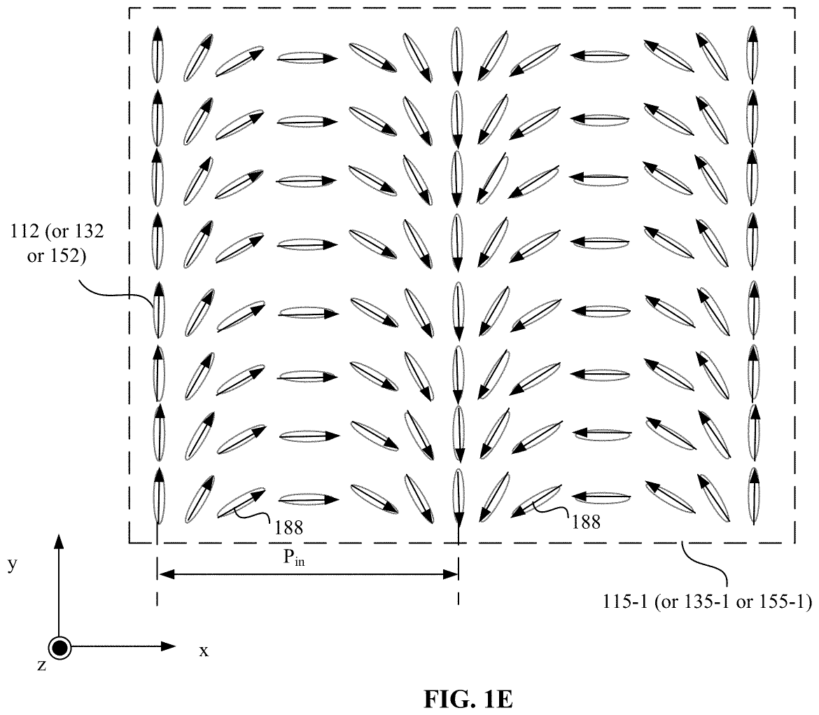

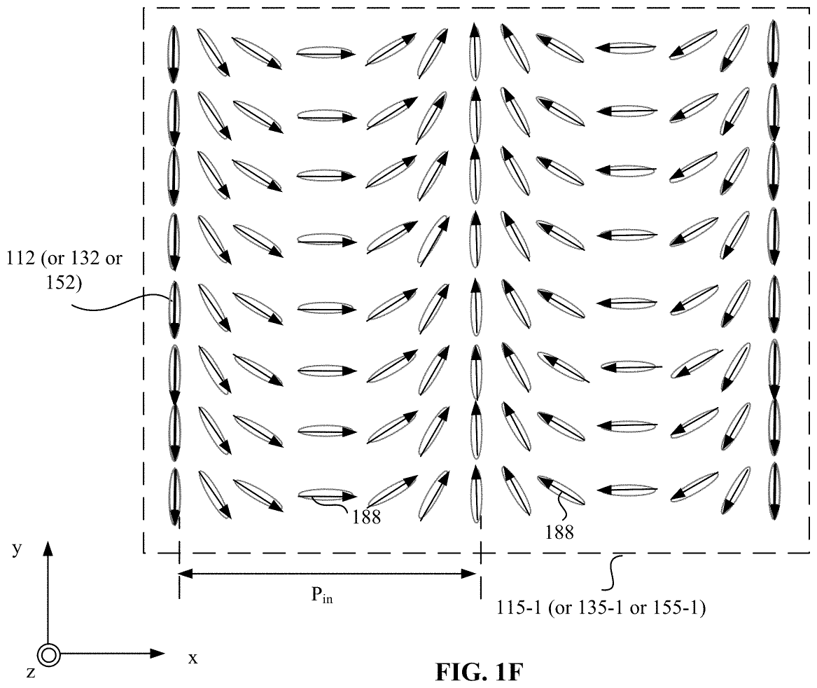

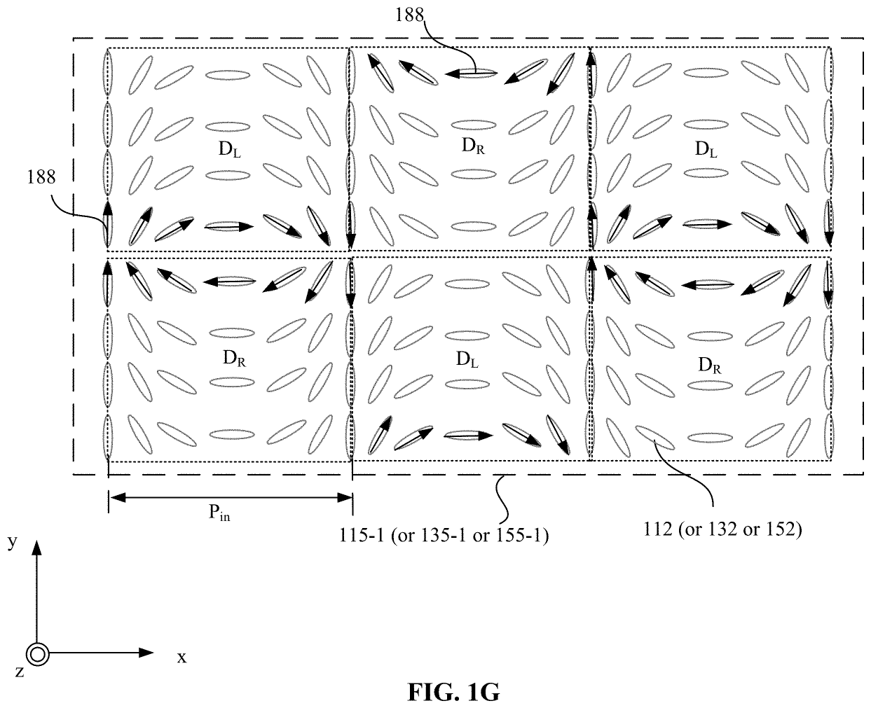

FIG. 1A illustrates a schematic three-dimensional (“3D”) view of a PVH element 100, according to an embodiment of the present disclosure. As shown in FIG. 1A, an incident light 102 may be incident onto the PVH element 100 along a −z-axis. The PVH element 100 may include a birefringent medium in a form of a layer (or a film, a plate). The layer is also referred to as a PVH film 115, a birefringent film 115, a birefringent medium layer 115. In some embodiments, the PVH element 100 may also include other elements, e.g., a substate at which the PVH film 115 is disposed. In some embodiments, the PVH element 100 may also include an alignment structure (such as an alignment layer) disposed between the substate and the PVH film 115. In some embodiments, the PVH element 100 may be fabricated based on a birefringent material including optically anisotropic molecules having an intrinsic orientational order that can be locally controlled. The birefringent material may exhibit a chirality. In some embodiments, the chirality of the birefringent material may be introduced by chiral dopants doped into a host birefringent material, e.g., introduced by chiral dopants doped into achiral nematic liquid crystals (“LCs”), or introduced by chiral reactive mesogens (“RMs”) doped into achiral RMs. In some embodiments, the chirality of the birefringent material may be a property of the birefringent material, such as an intrinsic molecular chirality. For example, the birefringent material may include chiral liquid crystal molecules, or the birefringent material may include molecules having one or more chiral functional groups. In some embodiments, the birefringent material with a chirality may include twist-bend nematic LCs (or LCs in twist-bend nematic phase), in which liquid crystal (“LC”) directors may exhibit periodic twist and bend deformations forming a conical helix with doubly degenerate domains having opposite handednesses. The LC directors of twist-bend nematic LCs may be tilted with respect to the helical axis. Thus, the twist-bend nematic phase may be considered as the generalized case of the conventional nematic phase in which the LC directors are orthogonal with respect to the helical axis. In some embodiments, the PVH element 100 may be fabricated based on photosensitive polymers, such as amorphous polymers, LC polymers, etc., which may generate an induced (e.g., photo-induced) optical anisotropy and induced (e.g., photo-induced) local optic axis orientations when subjected to a polarized light irradiation. When subjected to a polarized light irradiation, the efficiency of photochemical reaction in the photosensitive polymers may depend on a polarization of an exciting light that results in a photo-induced orientation. When exposed to a polarization interference pattern, a 3D polarization field may be recorded into the volume of the photosensitive polymers.

The optically anisotropic molecules in the PVH film 115 may be arranged or aligned in a three-dimensional (“3D”) orientational pattern, based on which an optical function of the PVH element 100 may be determined. In some embodiments, an optic axis of the PVH film 115 may be configured with a spatially varying orientation in at least one in-plane direction. For example, the optic axis of the LC material may periodically or non-periodically vary in at least one in-plane linear direction, in at least one in-plane radial direction, in at least one in-plane circumferential (e.g., azimuthal) direction, or a combination thereof. The LC molecules may be configured with an in-plane orientation pattern, in which the directors of the LC molecules may periodically or non-periodically vary in the at least one in-plane direction. In some embodiments, the optic axis of the PVH film 115 may also be configured with a spatially varying orientation in an out-of-plane direction. The directors of the LC molecules may also be configured with spatially varying orientations in an out-of-plane direction. For example, the optic axis of the PVH film 115 (or directors of the LC molecules) may twist in a helical fashion in the out-of-plane direction.

FIGS. 1B-1D schematically illustrate portions of 3D orientational patterns of optically anisotropic molecules included in the PVH film 115 of the PVH element 100, according to various embodiments of the present disclosure. FIGS. 1E-1G schematically illustrate portions of periodic in-plane orientation patterns of the optically anisotropic molecules within a film plane of the PVH film 115 shown in FIGS. 1B-1D, according to various embodiments of the present disclosure. For discussion purposes, rod-like LC molecules are used as examples of the optically anisotropic molecules of the PVH film 115. Each LC molecule in FIGS. 1B-1G is depicted as having a longitudinal direction (or a length direction) and a lateral direction (or a width direction). The longitudinal direction of the LC molecule is referred to as a director of the LC molecule or an LC director.

FIG. 1B schematically illustrates a portion of a 3D orientational pattern of LC molecules 112 included in the PVH film 115 of the PVH element 100. As shown in FIG. 1B, the PVH film 115 may have a first surface 115-1 and a second surface 115-2 facing the first surface 115-1. Although the PVH film 115 is shown as flat for illustrative purposes, the PVH film 115 may have a non-flat shape (e.g., a curved shape). In a volume of the PVH film 115, the LC molecules 112 may be arranged in a plurality of helical structures 117 with a plurality of helical axes 118 and a helical pitch Pₕ. Directors of the LC molecules 112 included in a same helical structure 117 along a helical axis 118 may exhibit continuous spatial rotation around the helical axis 118 in a predetermined rotation direction (e.g., clockwise direction or counter-clockwise direction). Accordingly, the helical structure 117 may exhibit a handedness, e.g., right handedness or left handedness. The helical pitch Pₕ is defined as a distance along the helical axis 118 over which the LC directors (or azimuthal angles of the LC molecules) rotate by 360°. The azimuthal angle of the LC molecules 112 is defined as an angle between the LC director and a direction (e.g., a +x-axis direction) in a plane parallel with a surface of the PVH film 115.

In the embodiment shown in FIG. 1B, the helical axes 118 of the helical structures 117 may be parallel with one another. The helical axes 118 may have a direction that is substantially perpendicular to the first surface 115-1 and/or the second surface 115-2 of the PVH film 115. In other words, the helical axes 118 of the helical structures 117 may have a direction along a thickness direction (e.g., a z-axis direction) of the PVH film 115. In some embodiments, the LC molecules 112 may be aligned to have substantially small pretilt angles (including zero degree pretilt angle), and the LC directors of the LC molecules 112 may be regarded as substantially orthogonal to the helical axis 118. The PVH film 115 (or the PVH element 100 including the PVH film 115) may have a vertical pitch Pᵥ, which is defined as a distance along the thickness direction of the PVH film 115 over which the LC directors rotate by 180°. The vertical pitch Pᵥ shown in FIG. 1B may be half of the helical pitch Pₕ.

In some embodiments, the LC molecules 112 within a film plane of the PVH film 115, may be configured with continuously rotating LC directors in a predetermined direction (e.g., an x-axis direction) within the film plane. The film plane may be parallel with at least one of the first surface 115-1 or the second surface 115-2. The film plane may be perpendicular to the thickness direction of the birefringent medium layer 115. The continuous rotation of the LC directors may form a periodic rotation pattern with a uniform (e.g., same) in-plane pitch Pᵢₙ. The predetermined direction may be any suitable direction within the film plane. For illustrative purposes, FIG. 1B shows that the predetermined direction is the x-axis direction. For example, the LC molecules 112 distributed in the x-axis direction may have LC directors having different orientations. The different orientations of the LC directors may exhibit a continuous rotation in the x-axis direction. The predetermined direction may be referred to as an in-plane direction, the pitch Pᵢₙ along the in-plane direction may be referred to as an in-plane pitch or a horizontal pitch. The pattern with the uniform (or same) in-plane pitch Pᵢₙ may be referred to as a periodic LC director in-plane orientation pattern.

FIG. 1E schematically illustrates a portion of the periodic in-plane orientation pattern of the directors (indicated by arrows 188 in FIG. 1E) of the LC molecules 112 within a film plane of the PVH film 115, according to an embedment of the present disclosure. The in-plane pitch Pᵢₙ is defined as a distance along the in-plane direction (e.g., the x-axis direction) over which the LC directors rotate by 180°. In other words, in a region substantially close to (including at) the surface of the PVH film 115, local optic axis orientations of the PVH film 115 may vary periodically in the in-plane direction (e.g., the x-axis direction) with a pattern having the uniform (or same) in-plane pitch Pᵢₙ. In addition, at a surface (e.g., at least one of the first surface 115-1 or the second surface 115-2) of the PVH film 115, the directors of the LC molecules 112 may rotate in a predetermined rotation direction, e.g., a clockwise direction or a counter-clockwise direction. Accordingly, the rotation of the directors of the LC molecules 112 at the surface of the PVH film 115 may exhibit a handedness, e.g., right handedness or left handedness. In some embodiments, the periodic LC director in-plane orientation pattern or the periodic local optic axis orientation pattern of the PVH film 115 may be obtained by patterning a recording medium or an alignment surface using various techniques, such as holography techniques. In the embodiment shown in FIG. 1E, at the surface (e.g., at least one of the first surface 115-1 or the second surface 115-2) of the PVH film 115, the directors of the LC molecules 112 may rotate in a clockwise direction. Accordingly, the rotation of the directors of the LC molecules 112 at the surface of the PVH film 115 may exhibit a left handedness.

FIG. 1F schematically illustrates a portion of the periodic in-plane orientation pattern of the directors (indicated by arrows 188 in FIG. 1F) of the LC molecules 112 within a film plane of the PVH film 115, according to another embedment of the present disclosure. In the embodiment shown in FIG. 1F, at the surface (e.g., at least one of the first surface 115-1 or the second surface 115-2) of the PVH film 115, the directors of the LC molecules 112 may rotate in a counter-clockwise direction. Accordingly, the rotation of the directors of the LC molecules 112 at the surface of the PVH film 115 may exhibit a right handedness. The orientations of directors of the LC molecules 112 within the film plane of the PVH film 115 shown in FIG. 1E and the orientations of directors of the LC molecules 112 within the film plane of the PVH film 115 shown in FIG. 1F may have mirror symmetric orientation patterns.

FIG. 1G schematically illustrates a portion of the periodic in-plane orientation pattern of the directors (indicated by arrows 188 in FIG. 1G) of the LC molecules 112 within a film plane of the PVH film 115, according to another embedment of the present disclosure. It is noted that in FIG. 1G, only some directors are indicated by arrows 188. Arrows are not shown for all directors for the simplicity of illustration. In the embodiment shown in FIG. 1G, at the surface (e.g., at least one of the first surface 115-1 or the second surface 115-2) of the PVH film 115, domains in which the directors of the LC molecules 112 may rotate in a clockwise direction (referred to as domains DL) and domains in which the directors of the LC molecules 112 may rotate in a counter-clockwise direction (referred to as domains DR) may be alternatingly arranged in both x-axis and y-axis direction. The domains DL and the domains DR are schematically enclosed by dotted squares. In some embodiments, the DL and the domains DR may have substantially the same size. The width of each domain may be substantially equal to the value of the in-plane pitch Pᵢₙ. Although not shown, in some embodiments, the domains DL and the domains DR may be alternatingly arranged in at least one direction along the surface of the (e.g., at least one of the first surface 115-1 or the second surface 115-2) of the PVH film 115. In some embodiments, the width of each domain may be an integer multiple of the values of the in-plane pitch Pin. In some embodiments, the domains DL and the domains DR may have different sizes.

Referring back to FIG. 1B, in a volume of the PVH film 115, the LC molecules 112 may be arranged in a plurality of helical structures 117 with a plurality of helical axes 118 and a helical pitch Pₕ along the helical axes. The azimuthal angles of the LC molecules 112 arranged along a single helical structure 117 may continuously vary around a helical axis 118 in a predetermined rotation direction, e.g., clockwise direction or counter-clockwise direction. In other words, the LC directors of the LC molecules 112 arranged along a single helical structure 117 may continuously rotate around the helical axis 118 in a predetermined rotation direction to continuously change the azimuthal angle. Accordingly, the helical structure 117 may exhibit a handedness, e.g., right handedness or left handedness. The helical pitch Pₕ may be defined as a distance along the helical axis 118 over which the LC directors rotate around the helical axis 118 by 360°, or the azimuthal angles of the LC molecules vary by 360°.

In the embodiment shown in FIG. 1B, the helical axes 118 may be substantially perpendicular to the first surface 115-1 and/or the second surface 115-2 of the PVH film 115. In other words, the helical axes 118 of the helical structures 117 may be in a thickness direction (e.g., a z-axis direction) of the PVH film 115. That is, the LC molecules 112 may have substantially small tilt angles (including zero degree tilt angles), and the LC directors of the LC molecules 112 may be substantially orthogonal to the helical axis 118. The PVH film 115 (or the PVH element 100 including the PVH film 115) may have a vertical pitch Pᵥ, which may be defined as a distance along the thickness direction of the PVH film 115 over which the LC directors of the LC molecules 112 rotate around the helical axis 118 by 180° (or the azimuthal angles of the LC directors vary by 180°).

As shown in FIG. 1B, the LC molecules 112 from the plurality of helical structures 117 having a first same orientation (e.g., same tilt angle and azimuthal angle) may form a first series of slanted and parallel refractive index planes 114 periodically distributed within the volume of the PVH film 115. Although not labeled, the LC molecules 112 with a second same orientation (e.g., same tilt angle and azimuthal angle) different from the first same orientation may form a second series of slanted and parallel refractive index planes periodically distributed within the volume of the PVH film 115. Different series of slanted and parallel refractive index planes may be formed by LC molecules 112 having different orientations. In the same series of parallel and periodically distributed, slanted refractive index planes 114, the LC molecules 112 may have the same orientation and the refractive index may be the same. Different series of slanted refractive index planes may correspond to different refractive indices. When the number of the slanted refractive index planes (or the thickness of the PVH film) increases to a sufficient value, Bragg diffraction may be established according to the principles of volume gratings. Thus, the slanted and periodically distributed refractive index planes 114 may also be referred to as Bragg planes 114. Thus, within the PVH film 115, there exist different series of Bragg planes.

A distance (or a period) between adjacent Bragg planes 114 of the same series may be referred to as a Bragg period PB. The different series of Bragg planes formed within the volume of the PVH film 115 (or the volume of the PVH element 100) may produce a varying refractive index profile that is periodically distributed in the volume of the PVH film 115. The PVH film 115 (or the PVH element 100) may diffract an input light substantially satisfying a Bragg condition through Bragg diffraction. A slant angle α of the PVH element 100 including the PVH film 115 may be defined as α=90°−β, where βP=arctan (Pᵥ/Pₓ). That is, the slant angle may be a function of the vertical pitch and the horizontal in-plane pitch. Specifically, the slant angle may be a function of a ratio between the vertical pitch and the horizontal in-plane pitch. In some embodiments, the PVH element 100 including the PVH film 115 shown in FIG. 1B with a tilt angle 0°<α<45°, may function as a transmissive PVH.

FIG. 1C illustrates a portion of a 3D orientational pattern of LC molecules 132 included in a PVH film 135, according to another embodiment of the present discourse. Similar to the LC molecules 112 within the film plane of the PVH film 115 shown in FIG. 1B and FIGS. 1E-1G, the LC molecules 132 within the film plane of the PVH film 135 may be configured with LC directors that exhibit a continuous and periodic rotation in a predetermined rotation direction (e.g., clockwise or counter-clockwise) along a predetermined in-plane direction (e.g., an x-axis direction) at the surface or in a plane parallel with the surface. That is, orientations of LC directors may vary continuously and periodically in the predetermined in-plane direction (e.g., an x-axis direction) along the surface or the plane parallel with the surface. The continuous rotation may have an in-plane rotation pattern with an in-plane pitch Pₓ. In some embodiments, the in-plane pitch Pₓ may be uniform (or same). The LC molecules may form a plurality of Bragg planes 134 similar to the Bragg planes 114 shown in FIG. 1B. FIGS. 1E-1G show the periodic in-plane rotation pattern of LC directors of the LC molecules 132 within the film plane of the PVH film 135.

In the embodiment shown in FIG. 1C, helical axes 138 of helical structures 137 may be tilted with respect to a first surface 135-1 and/or a second surface 135-2 of the PVH film 135 (or with respect to the thickness direction of the PVH film 135). For example, the helical axes 138 of the helical structures 137 may have an acute angle or obtuse angle with respect to the first surface 135-1 and/or the second surface 135-2 of the PVH film 135. In some embodiments, the LC directors of the LC molecule 132 may be substantially orthogonal to the helical axes 138 (i.e., the tilt angle may be substantially zero degree). In some embodiments, the LC directors of the LC molecule 132 may be tilted with respect to the helical axes 138 at an acute angle. The PVH film 135 (or the PVH element 100 including the PVH film 135) may have a vertical periodicity (or pitch) Pᵥ. A slant angle α of the PVH element 100 including the PVH film 135 may be defined as α=90°−β, where β=arctan (Pᵥ/Pₓ). In some embodiments, the PVH element 100 including the PVH film 135 shown in FIG. 1C with a tilt angle 45°<α<90°, may function as a reflective PVH.

FIG. 1D illustrates a portion of a schematic 3D orientational pattern of LC molecules 152 included in a PVH film 155, according to another embodiment of the present discourse. As shown in FIG. 1D, the PVH film 155 may include a first surface 155-1 and a second surface 155-2 facing the first surface 155-1. Similar to the LC molecules 112 within the film plane of the PVH film 115 shown in FIG. 1B and FIGS. 1E-1G, the LC molecules 152 within the film plane of the PVH film 155 may be configured with LC directors that exhibit a continuous rotation in a predetermined rotation direction (e.g., clockwise) along a predetermined in-plane direction (e.g., an x-axis direction) at the surface or in a plane parallel with the surface. The continuous rotation may exhibit a periodic in-plane rotation pattern with an in-plane pitch Pᵢₙ (which is Pₓ in this example). In some embodiments, the in-plane pitch Pᵢₙ may be uniform (e.g., same) or may vary in the predetermined in-plane direction (e.g., the x-axis direction). FIGS. 1E-1G also show the periodic in-plane rotation pattern of the orientations of the LC directors of the LC molecules 152 within the film plane of the PVH film 155.

Referring back to FIG. 1D, in the volume of the PVH film 155, the LC molecules 152 may be arranged in a plurality of series of slanted and periodic refractive index planes (or Bragg planes) 154, similar to the configuration shown in FIG. 1B. The PVH film 155 (or the PVH element 100 including the PVH film 155) may also have a vertical periodicity (or pitch) Pᵥ in a thickness direction of the PVH film 155. A slant angle α of the PVH element 100 including the PVH film 155 may be defined as α=90°−β, where β=arctan (Pᵥ/Pₓ). In some embodiments, the PVH element 100 including the PVH film 155 shown in FIG. 1D with a slant angle of 0°<α<45° may function as a transmissive PVH.

The periodic in-plane rotation pattern of the directors of the LC molecules within the film plane of the PVH film (or the periodic local optic axis orientations of the PVH film at a surface of the PVH film) shown in FIGS. 1E-1G is for illustrative purposes only, which is not intended to limit the scope of the present disclosure. For example, in some embodiments, the directors of the LC molecules within the film plane of the PVH film (or the local optic axis orientations of the PVH film within a film plane of the PVH film) may be configured to have an in-plane orientation pattern with a varying pitch in at least one in-plane direction.

In some embodiments, the PVH element 100 may be configured to primarily (or substantially) diffract a circularly polarized light (or an elliptically polarized light) having a predetermined handedness, and primarily (or substantially) transmit (e.g., with negligible diffraction) a circularly polarized light (or an elliptically polarized light) having a handedness that is opposite to the predetermined handedness. It is understood that the PVH element 100 may also transmit (e.g., with negligible diffraction) the circularly polarized light (or the elliptically polarized light) having the predetermined handedness, with a much smaller light transmittance than the circularly polarized light (or the elliptically polarized light) having the handedness that is opposite to the predetermined handedness. The PVH element 100 may also diffract the circularly polarized light (or the elliptically polarized light) having the handedness that is opposite to the predetermined handedness, with a much smaller diffraction efficiency than the circularly polarized light (or the elliptically polarized light) having the predetermined handedness. An unpolarized light or a linearly polarized light may be decomposed into two circularly polarized components (e.g., a first component and a second component) with opposite handednesses. Thus, the first component may be relatively strongly diffracted by the PVH element 100 and relatively weakly transmitted by the PVH element 100, and the second component may be relatively strongly transmitted (e.g., with negligible diffraction) by the PVH element 100, and relatively weakly diffracted by the PVH element 100. In some embodiments, to enhance the image quality of the see-through views, it may be highly desirable to reduce the rainbow effects caused by both of the relatively strong diffraction of the first component and the relatively weak diffraction of the second component.

The PVH element 100 may be configured to primarily forwardly or backwardly diffract the circularly polarized light (or the elliptically polarized light) having the predetermined handedness. When the PVH element 100 is configured to primarily forwardly diffract the circularly polarized light (or the elliptically polarized light) having the predetermined handedness, the PVH element 100 may be referred to as a transmissive PVH element 100. When the PVH element 100 is configured to primarily backwardly diffract the circularly polarized light (or the elliptically polarized light) having the predetermined handedness, the PVH element 100 may be referred to as a reflective PVH element 100.

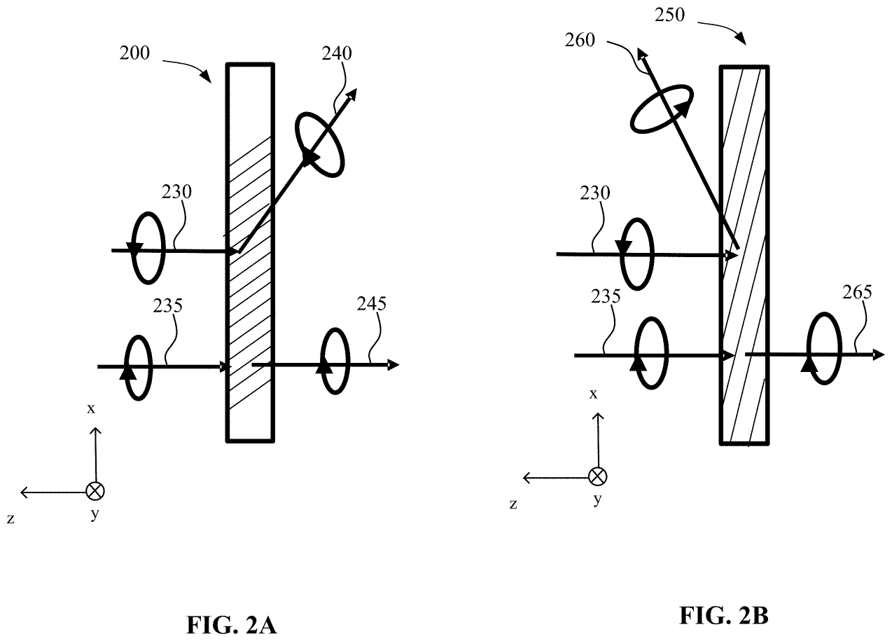

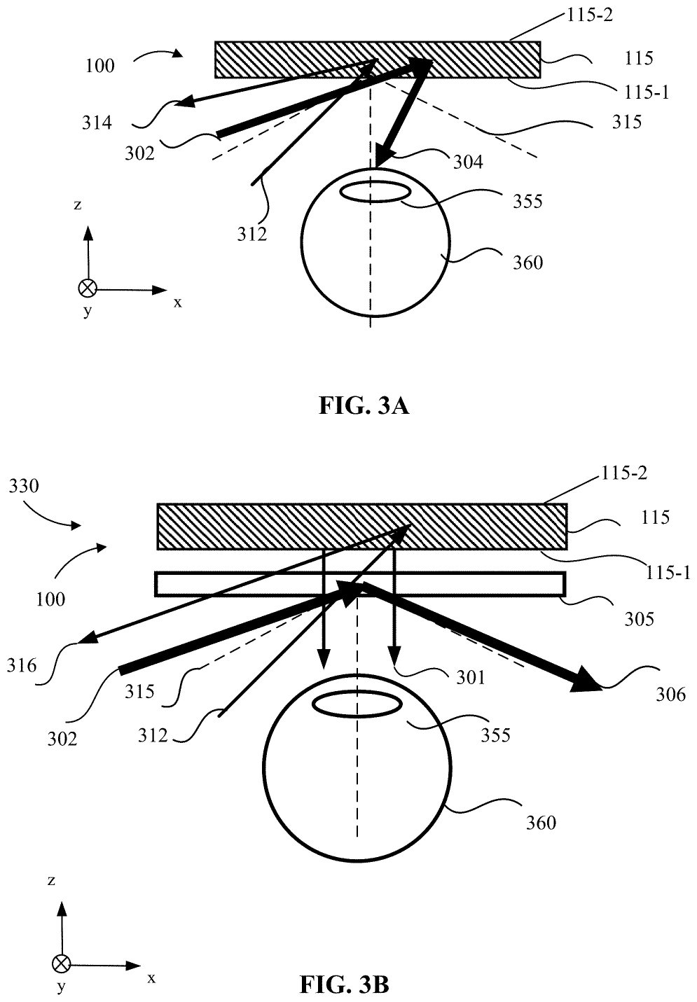

FIG. 2A illustrates diffraction orders of the PVH element 100 functioning as a transmissive PVH element 200, according to an embodiment of the present disclosure. The transmissive PVH element 200 may be configured to primarily forwardly diffract a circularly polarized light having a predetermined handedness (e.g., a handedness that is the same as the handedness of the rotation of the LC directors at the LC director plane) as a diffracted light of a certain order (e.g., the first order diffracted light). The transmissive PVH element 200 may primarily transmit (e.g., with negligible diffraction) a circularly polarized light having a handedness that is opposite to the predetermined handedness (e.g., a handedness that is opposite to the handedness of the rotation of the LC directors at the LC director plane of the PVH element 200) as a transmitted light (the 0^{th} order). In some embodiments, the transmissive PVH element 200 may be configured to reverse the handedness of the circularly polarized light diffracted thereby. For example, the diffracted light output from the transmissive PVH element 200 may be a circularly polarized light with a handedness reversed by the transmissive PVH element 200. In some embodiments, the transmissive PVH element 200 may be configured to maintain the handedness of the circularly polarized light transmitted thereby. For example, the transmitted light may be a circularly polarized light with a handedness substantially maintained by the transmissive PVH element 200.

For discussion purposes, FIG. 2A shows the transmissive PVH element 200 as a right-handed transmissive PVH, which is configured to primarily forwardly diffract an RHCP light 230 as an LHCP light 240, and primarily transmit (e.g., with negligible diffraction) an LHCP light 235 to the 0^{th} order as an LHCP light 245. In some embodiments, the transmissive PVH element 200 may change the polarization of the diffracted light and/or transmitted light. The transmission of the RHCP light 230 and the forward diffraction of the LHCP light 235 are not shown in FIG. 2A. In some embodiments, to enhance the image quality of the see-through views, it may be highly desirable to reduce the rainbow effects caused by both of the relatively strong diffraction of the RHCP light 230 and the relatively weak diffraction of the LHCP light 235.

FIG. 2B illustrates diffraction orders of the PVH element 100 functioning as a reflective PVH element 250, according to an embodiment of the present disclosure. The reflective PVH element 250 may be configured to primarily backwardly diffract a circularly polarized light (or an elliptically polarized light) having a predetermined handedness as a diffracted light of a certain order (e.g., the first order diffracted light), and primarily transmit (e.g., with negligible diffraction) a circularly polarized light having a handedness that is opposite to the predetermined handedness as a transmitted light (the 0^{th} order). In some embodiments, the reflective PVH element 250 may be configured to substantially maintain the handedness of the circularly polarized light diffracted thereby and the handedness of the circularly polarized light transmitted thereby. For example, the diffracted light may be a circularly polarized light with a handedness substantially maintained by the reflective PVH element 250, and the transmitted light may be a circularly polarized light with a handedness substantially maintained by the reflective PVH element 250.

For discussion purposes, FIG. 2B shows that the reflective PVH element 250 is a right-handed reflective PVH, which is configured to primarily backwardly diffract an RHCP light 230 as an RHCP light 260, and primarily transmit (e.g., with negligible diffraction) an LHCP light 235 to the 0^{th} order as an LHCP light 265. In some embodiments, the reflective PVH element 250 may change the polarization of the diffracted light and/or transmitted light. For example, in some embodiments, the diffracted light may be an elliptically polarized light or a linearly polarized light. In some embodiments, the transmitted light may be an elliptically polarized light or a linearly polarized light. The transmission of the RHCP light 230 and the backward diffraction of the LHCP light 235 are not shown in FIG. 2B. In some embodiments, to enhance the image quality of the see-through views, it may be highly desirable to reduce the rainbow effects caused by both of the relatively strong diffraction of the RHCP light 230 and the relatively weak diffraction of the LHCP light 235.

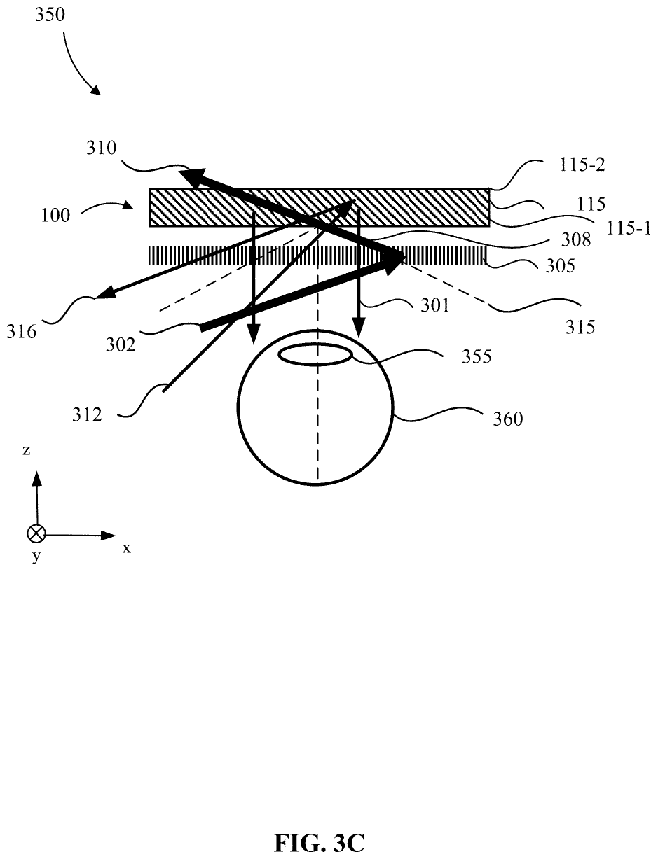

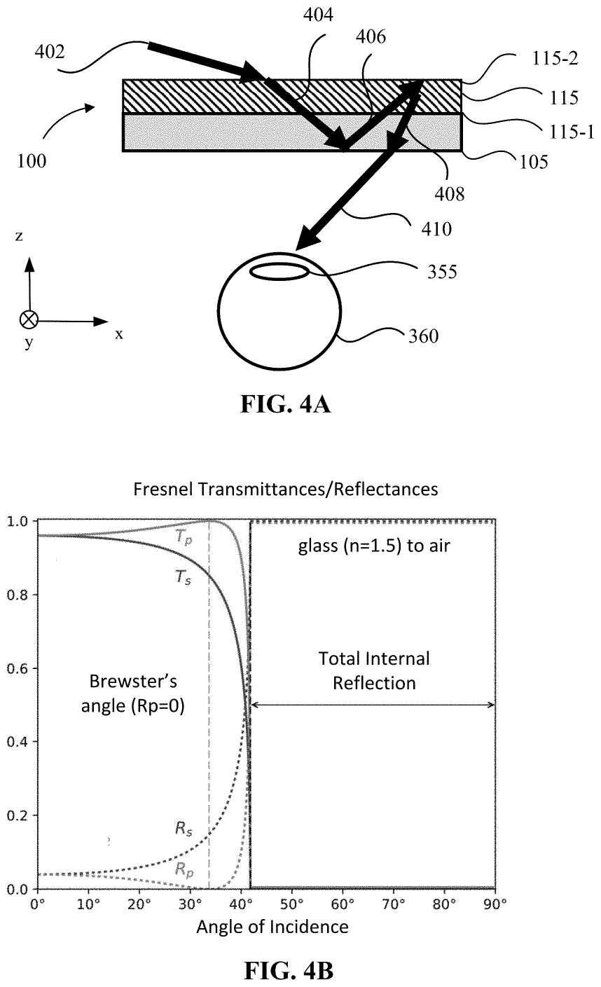

FIGS. 3A, 4A, and 5A illustrate schematic diagrams showing rainbow effects that may be caused by the PVH element 100 shown in FIG. 1A. The PVH element 100 may be disposed in front of an eye 360 of the user. The PVH film 115 of the PVH element 100 may include the first surface 115-1 facing the eye 360 of the user, and the second surface 115-2 opposing the first surface 115-1. In some embodiments, the PVH element 100 may function as a reflective PVH element. In some embodiments, the PVH element 100 may function as a transmissive PVH element. The PVH element 100 may be a part of a system (e.g., an NED, an HUD, an HMD, a smart phone, a laptop, or a television, etc.) for VR, AR, and/or MR applications. For example, the system for VR, AR, and/or MR applications may include a display system, a viewing optical system, and an eye tracking system, and a controller. The controller may be electrically coupled with, and may control, various devices in the display system, the viewing optical system, and the eye tracking system. The display system may include image display components configured to project an image light (forming computer-generated virtual images) into a display window in (or within) a field of view (“FOV”) of the display system. The viewing optical system may be configured to guide the image light output from the display system to an exit pupil. The exit pupil may be a location where an eye pupil 355 of the eye 360 of the user is positioned in an eye-box region of the display system. The eye tracking system may be configured to provide eye-tracking information. The eye-tracking information may include at least one of a position, an orientation, or a gaze direction of the eye or eyes. For example, the position of the eye pupil 355, and the gaze directions of the user may be determined based on the eye-tracking information. In some embodiments, the PVH element 100 may function as an image display component of the display system. For example, the display system may be a light guide display system, and the PVH element 100 may function as an out-coupling element coupled to a light guide. The PVH element 100 may couple the image light out of the light guide toward the eye-box region. In some embodiments, the PVH element 100 may function as an IR light deflecting component of the eye tracking system.

FIG. 3A illustrates a diagram showing a rainbow effect resulting from a backward diffraction of a real-world light 302 (e.g., a visible polychromatic light) by the PVH element 100. The real-world light 302 may be incident onto the PVH element 100 from the same side of the PVH element 100 as the user. For illustrative purposes, FIG. 3A shows that the light 302 is incident onto the PVH element 100 from a left side of the user. The PVH element 100 may backwardly diffract the light 302, when the Bragg condition is substantially satisfied, as a diffracted light 304 propagating toward the eye 360, causing a multicolored glare (i.e., the rainbow effect) in a see-through view when the user looks through the PVH element 100. Such a rainbow effect may be referred to as a reflective rainbow effect.

The inventors of the present disclosure have observed that the rainbow effect mostly result from a real-world light having a large incidence angle greater than or equal to a first predetermined angle (e.g., 50°, 60°, or 65°, etc.) at the PVH element 100, because such a real-world light may be diffracted to the eye 360 by the PVH element 100. The real-world light having a small incidence angle less than the first predetermined angle (e.g., 50°, 60°, or 65°) at the PVH element 100 may be diffracted by the PVH element 100 in a direction such that the diffracted light is out of user's sight, or out of an FOV of a system including the PVH element 100, which may not cause the rainbow effect in the see-through view. For discussion purposes, a rainbow effect incidence angle range (also referred to as a first predetermined angle range) may be defined for the PVH element 100, which may include incidence angles greater than or equal to the first predetermined angle. For example, rainbow effect incidence angle range may be 50°-80°, 60°-80°, 65°-80°, 70°-80°, 50°-90°, 60°-90°, 65°-90°, 70°-90°, etc.

As shown in FIG. 3A, the real-world light 302 may be incident onto the PVH element 100 at a large incidence angle within the rainbow effect incidence angle range associated with the PVH element 100. Accordingly, the real-world light 302 may be backwardly diffracted by the PVH element 100 to the eye 360, causing rainbow effects in the see-through view. A real-world light 312 having a small incidence angle less than the first predetermined angle (e.g., 50°, 60°, or 65°) at the PVH element 100, e.g., outside of and less than a lower limit of the rainbow effect incidence angle range, may be diffracted as a diffracted light 314 in a direction such that the diffracted light 314 is out of user's sight, or out of an FOV 315 of a system including the PVH element 100. Hence, the real-world light 312 may not cause the rainbow effect in the see-through view. In some embodiments, the FOV 315 of the system including the PVH element 100 may have an angular range of about +25° to −25°, +30° to −30°, about +40° to −40°, or about +50° to −50°.

FIGS. 3B and 3C illustrate x-z sectional views of optical devices 330 and 350 for suppressing the rainbow effect shown in FIG. 3A, according to various embodiments of the present disclosure. As shown in FIGS. 3B and 3C, the optical device 330 or 350 may include the PVH element 100, and an optical filter 305 stacked in an optical series. The optical filter 305 may be disposed between the PVH element 100 and the eye 360. In some embodiments, the optical filter 305 may be located substantially within the FOV 315 of a system including the PVH element 100. For illustrative purposes, FIGS. 3B and 3C show that the PVH element 100 and the optical filter 305 are spaced apart from one another with a gap. In some embodiments, the PVH element 100 and the optical filter 305 may be directly coupled to one another without a gap therebetween. In some embodiments, the PVH element 100 and the optical filter 305 may be directly coupled to one another without another optical element disposed therebetween. In some embodiments, the PVH element 100 and the optical filter 305 may be indirectly coupled to one another with another optical element (e.g., a compensation plate) disposed therebetween.

The optical filter 305 may be an angularly selective optical element configured to selectively deflect or transmit an incident light, depending on an incidence angle of the light at the optical filter 305. The optical filter 305 may be configured to deflect the incident light via any suitable mechanisms, such as reflection, diffraction, scattering, and/or absorption, etc. The optical filter 305 may be any suitable angularly selective optical filter, such as a dye-doped absorptive film or privacy film, a holographic optical element (“HOE”) (e.g., a transmissive type HOE), an LCPH element (e.g., a reflective PVH element, a transmissive PVH element, etc.), etc.

In some embodiments, when the incidence angle is greater than or equal to a second predetermined angle (e.g., 50°, 60°, or 65°, etc.), the optical filter 305 may be configured to substantially deflect the incident light. In some embodiments, when the incidence angle is less than the second predetermined angle (e.g., 50°, 60°, or 65°, etc.), the optical filter 305 may be configured to substantially transmit the incident light with negligible deflection. For example, the optical filter 305 may substantially deflect the incident light, when the incidence angle of the light is within a predetermined incidence angle range for deflection (also referred to as a second predetermined angle range). The optical filter 305 may substantially transmit the incident light with negligible deflection, when the incidence angle of the light is outside of and less than a lower limit of the second predetermined angle range.

The predetermined incidence angle range for deflection (or the second predetermined angle range) may encompass, include, coincide with, or overlap with the predetermined rainbow effect incidence angle range (or the first predetermined angle range). For example, a light having an incidence angle that is within the predetermined rainbow effect incidence angle range associated with the PVH element 110 may also fall within the predetermined incidence angle range for deflection associated with the optical filter 305. In some embodiments, the predetermined incidence angle range for deflection may include relatively large incidence angles. For example, the predetermined incidence angle range for deflection may be 50°-80°, 60°-80°, 65°-80°, 70°-80°, 50°-90°, 60°-90°, 65°-90°, 70°-90°, etc.

In the embodiment shown in FIG. 3B, the optical filter 305 may be configured to backwardly deflect a light incident onto the optical filter 305 at an incidence angle greater than or equal to the second predetermined angle, e.g., within the predetermined incidence angle range for deflection. In some embodiments, the optical filter 305 may be a reflective PVH element configured to deflect an incident light, via backward diffraction when the Bragg condition is substantially satisfied. As shown in FIG. 3B, as the incidence angle of the real-world light 302 at the optical filter 305 within the predetermined incidence angle range for deflection, the optical filter 305 may backwardly deflect the light 302 as a deflected light 306 in a direction such that the deflected light 306 is out of the FOV 315 of the display system. The real-world light 302 may be substantially blocked by the optical filter 305 from being incident onto the PVH element 100. Thus, the real-world light 302 may not be diffracted by the PVH element 100 back to the eye 360 to cause the rainbow effect. Accordingly, the optical device 330 may significantly reduce or eliminate the rainbow effect that may otherwise be caused by the backward diffraction of a real-world light by the PVH element 110.

As the incidence angle of the real-world light 312 at the optical filter 305 is less than the second predetermined angle, e.g., outside of and less than a lower limit of the predetermined incidence angle range for deflection, the optical filter 305 may substantially transmit, with negligible deflection, the light 312 toward the PVH element 100. In some embodiments, the PVH element 100 may diffract the light 312 in a direction as a diffracted light 316 such that the diffracted light is out of user's sight, or out of an FOV 315 of the system including the PVH element 100. Thus, the real-world light 312 may not cause the rainbow effect in the see-through view.

In addition, an image light 301 output from the PVH element 100 (e.g., coupled out of a light guide via the PVH element 100) may be incident onto the optical filter 305. The image light 301 may represent a virtual image. The incidence angle of the image light 301 at the optical filter 305 may be less than the second predetermined angle (e.g., 50°, 60°, or 65°, etc.). Thus, the optical filter 305 may substantially transmit, with negligible deflection, the image light 301 toward the eye 360, without introducing a distortion in the virtual image formed by the image light 301.

In the embodiment shown in FIG. 3C, the optical filter 305 may be configured to forwardly deflect a light incident onto the optical filter 305 at an incidence angle that is greater than or equal to the second predetermined angle, e.g., within the predetermined incidence angle range for deflection. As shown in FIG. 3C, as the incidence angle of the light 302 at the optical filter 305 is within the predetermined incidence angle range for deflection, the optical filter 305 may forwardly deflect the light 302 as a deflected light 308 propagating toward the PVH element 100. The light 308 may be incident onto the PVH element 100 at an incidence angle, which may be the same as the deflection angle of the light 308 output from the optical filter 305. In some embodiments, the deflection angle of the light 308 output from the optical filter 305 may be configured, such that the light 308 does not satisfy the Bragg condition of the PVH element 100. Thus, the PVH element 100 may substantially transmit, with negligible diffraction, the light 308 as a light 310 propagating toward the real-world environment.

As shown in FIG. 3C, the light 308 may be incident onto the PVH element 100 at the first surface 115-1, and the light 310 may be output from the second surface 115-2 of the PVH element 100. The light 310 may propagate in a direction such that the light 310 is out of user's sight, or out of the FOV 315 of the display system. In other words, the combination of the PVH element 100 and the optical filter 305 may be configured to forwardly deflect the light 302 in a direction such that the light 310 is out of user's sight, or out of the FOV 315 of the display system. Thus, the real-world light 302 may not be backwardly diffracted by the PVH element 100 to the eye 360 to cause the rainbow effect. Accordingly, the optical device 350 may significantly reduce or eliminate the rainbow effect that may be caused by the backward diffraction of a real-world light by the PVH element 100.

As the incidence angle of the real-world light 312 at the optical filter 305 is less than the second predetermined angle (e.g., 50°, 60°, or 65°, etc.), e.g., outside of and less than a lower limit of the predetermined incidence angle range for deflection, the optical filter 305 may substantially transmit, with negligible deflection, the light 312 toward the PVH element 100. The PVH element 100 may diffract the light 312 in a direction as a diffracted light 316 such that the diffracted light 316 is out of user's sight, or out of the FOV 315 of the system including the PVH element 100. The real-world light 312 may not cause the rainbow effect in the see-through view observed by the user.

In addition, the image light 301 output from the PVH element 100 (e.g., coupled out of a light guide via the PVH element 100) may be incident onto the optical filter 305. The incidence angle of the image light 301 at the optical filter 305 may be less than the second predetermined angle (e.g., 50°, 60°, or 65°, etc.), e.g., outside of and less than a lower limit of the predetermined incidence angle range for deflection. Thus, the optical filter 305 may substantially transmit, with negligible deflection, the image light 301 toward the eye 360, without introducing a distortion in the virtual image formed by the image light 301.

In the embodiment shown in FIG. 3C, the optical filter 305 may include a transmissive PVH element, e.g., similar to the transmissive PVH element 200 shown in FIG. 2A. The transmissive PVH element is also referred to as 305 for discussion purposes. When the incidence angle of the light 302 at the transmissive PVH element 305 is greater than or equal to the second predetermined angle, e.g., within the predetermined incidence angle range for deflection, the transmissive PVH element 305 may substantially forwardly diffract the light 302 as the diffracted light 308 propagating toward the PVH element 100. In some embodiments, the parameters of the transmissive PVH element 305 (e.g., the orientations of Bragg planes in the transmissive PVH element 305) may be configured, such that the diffraction angle of the light 308 output from the transmissive PVH element 305 may be configured to be within a predetermined diffraction angle range. For example, in the embodiment shown in FIG. 3C, the Bragg planes (denoted by the solid black lines) in the transmissive PVH element 305 may be configured to be substantially perpendicular to the incidence surface of the transmissive PVH element 305. In some embodiments, the incidence angle of the light 308 at the first surface 115-1 of the PVH element 100 may be the same as the diffraction angle of the light 308 output from the transmissive PVH element 305, e.g., within the predetermined diffraction angle range. The light 308 having such an incidence angle may not satisfy the Bragg condition of the PVH element 100. Thus, the PVH element 100 may substantially transmit, with negligible diffraction, the light 308 as the light 310 propagating in the direction such that the light 310 is out of user's sight, or out of the FOV 315 of the display system.

The real-world light 312 may be incident onto the transmissive PVH element 305, with an incidence angle less than the second predetermined angle (e.g., 50°, 60°, or 65°, etc.). In some embodiments, the light 312 may not satisfy the Bragg condition of the transmissive PVH element 305. Thus, the transmissive PVH element 305 may substantially transmit, with negligible diffraction, the light 312 toward the PVH element 100. In some embodiments, the PVH element 100 may diffract the light 312 in a direction such that the diffracted light 316 is out of user's sight, or out of the FOV 315 of the system including the PVH element 100.

The image light 301 output from the PVH element 100 may be incident onto the transmissive PVH element 305, with an incidence angle less than the second predetermined angle (e.g., 50°, 60°, or 65°, etc.). In some embodiments, the image light 301 may not satisfy the Bragg condition of the transmissive PVH element 305. Thus, the transmissive PVH element 305 may substantially transmit, with negligible diffraction, the image light 301 toward the eye 360, without introducing a distortion in a virtual image formed by the image light 301.

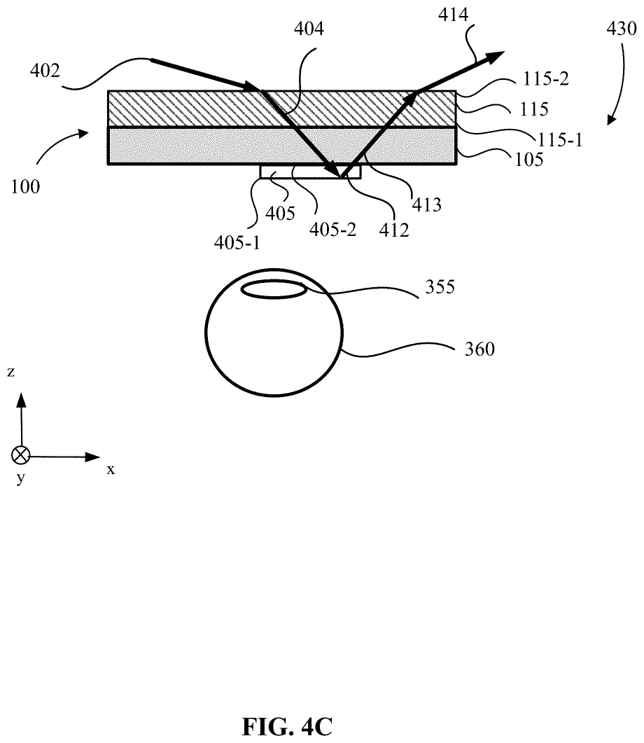

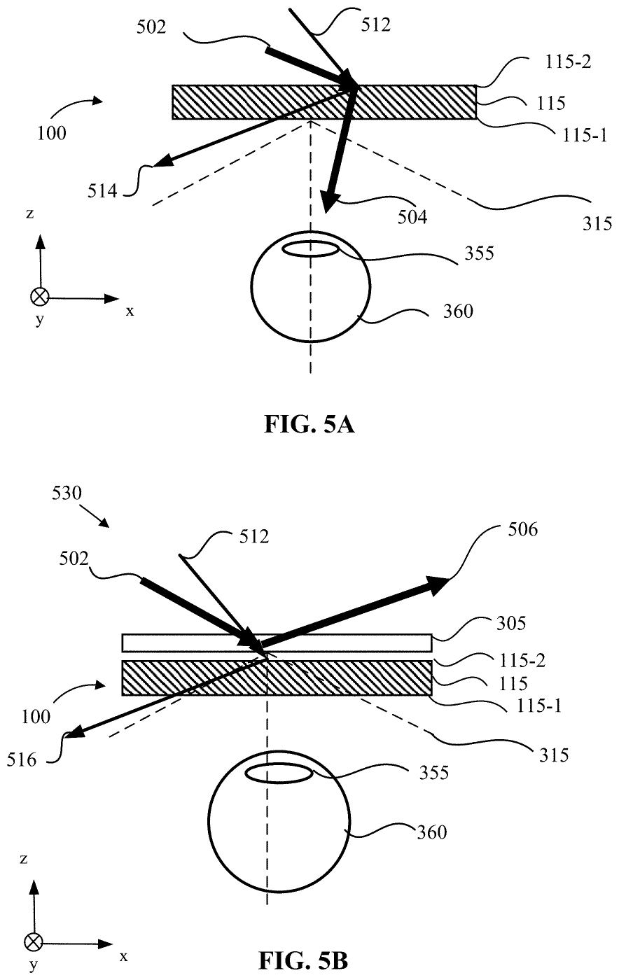

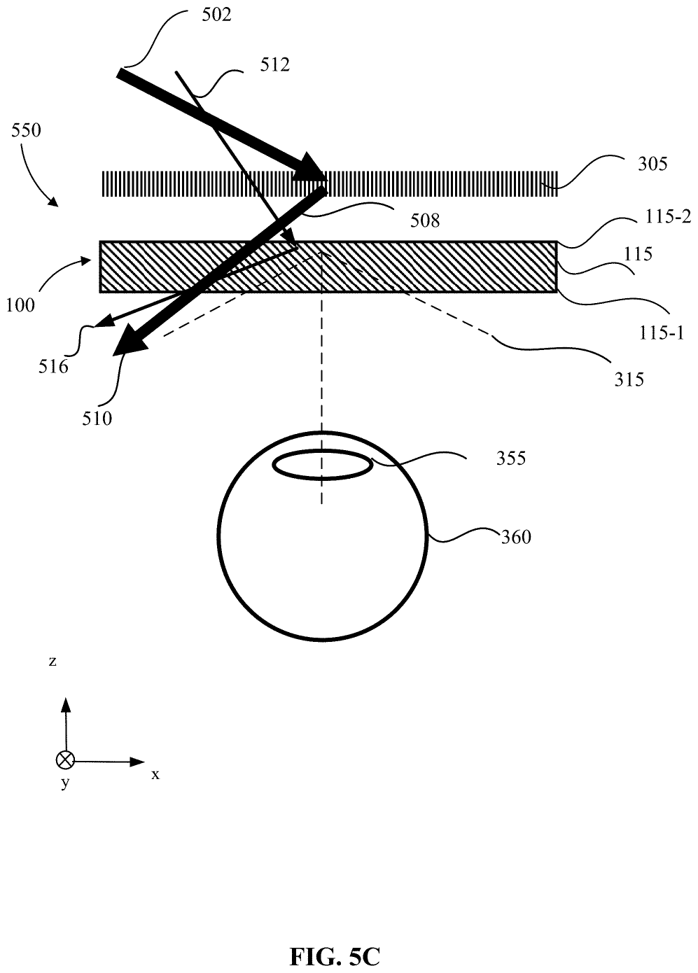

FIG. 4A illustrates a schematic diagram showing a rainbow effect caused by the PVH element 100 shown in FIG. 1A. A real-world light 402 may be incident onto the PVH element 100 from a first side of the PVH element 100 opposite to a second side where the eye 360 is located. In the embodiment shown in FIG. 4A, the rainbow effect may result from a Fresnel reflection of the light 402 at an interface between the PVH element 100 and the real-world environment (e.g., air). Such a rainbow effect may be referred to as a transmissive rainbow effect for discussion purposes.

As shown in FIG. 4A, the PVH element 100 may also include a substate 105. The PVH film 115 may be disposed at a surface of the substrate 105. For illustrative purposes, the substrate 105 and the PVH film 115 are shown as having flat surfaces. In some embodiments, the substrate 105 and the PVH film 115 may have curved surfaces. The substrate 105 may provide support and protection to various layers, films, and/or structures formed thereon. In some embodiments, the substrate 105 may also be at least partially transparent in the visible wavelength range (e.g., about 380 nm to about 700 nm). In some embodiments, the substrate 105 may also be at least partially transparent in at least a portion of the infrared (“IR”) band (e.g., about 700 nm to about 2 mm). The substrate 105 may include a suitable material that is at least partially transparent to lights of the above-listed wavelength ranges, such as, a glass, a plastic, a sapphire, or a combination thereof, etc. The substrate 105 may be rigid, semi-rigid, flexible, or semi-flexible. The substrate 105 may include a flat surface or a curved surface, on which the different layers or films may be formed. In some embodiments, the substrate 105 may also be a part of another optical element or device (e.g., another opto-electrical element or device). For example, the substrate 105 may be a solid optical lens, a part of a solid optical lens, a light guide, or a part of a light guide, etc.

In the embodiment shown in FIG. 4A, for discussion purposes, the first surface 115-1 of the PVH film 115 may be an interface between the air and the PVH film 115, and the second surface 115-2 of the PVH film 115 may be an interface between the substate 105 and the PVH film 115. The real-world light 402 may be incident onto the second surface 115-2 of the PVH film 115 (or the interface between the air and the PVH film 115), and may be refracted at the second surface 115-2 of the PVH film 115 as a light 404 propagating through the PVH film 115 and into the substate 105. The light 402 and the light 404 may be unpolarized lights. Then the light 404 may be reflected at an interface between the substate 105 and the air (e.g., a lower surface of the substate 105 shown in FIG. 4A) as a light 406 propagating through the substrate 105 and back into the PVH film 115.

The light 406 may be reflected at the second surface 115-2 of the PVH film 115 (or the interface between the air and the PVH film 115) as a light 408 propagating through the PVH film 115 and back into the substate 105. In some embodiments, the reflection of the light 406 at the second surface 115-2 of the PVH film 115 (or the interface between the air and the PVH film 115) may result in a dispersion in the reflected light. That is, the light 408 may be a dispersed light. The light 408 may be refracted at the lower surface of the substate 105 (or the interface between the substate 105 and the air) as a light 410 propagating toward the eye 360. In the embodiment shown in FIG. 4A, the reflection of the light 406 at the interface between the air and the PVH film 115 may cause a multicolored glare (i.e., the rainbow effect) in a see-through view when the user of the system looks through the PVH element 100.

In some embodiments, an anti-reflective or anti-reflection (“AR”) coating may be applied to the interface between the substate 105 and the air (e.g., the lower surface of the substate 105 shown in FIG. 4A). Thus, the intensity of the light 406 reflected from the interface between the substate 105 and the air (e.g., the lower surface of the substate 105 shown in FIG. 4A) may be decreased. Accordingly, the rainbow effect resulting from the Fresnel reflection of the light 406 at the interface between the air and the PVH film 115 may be reduced.

The inventors have observed that when the incidence angle of the light 404 at the interface between the substate 105 and the air (e.g., the lower surface of the substate 105 shown in FIG. 4A) is within a predetermined incidence angle range, the surface reflected light 406 may be a substantially s-polarized light. For example, in some embodiments, the substrate 105 may be a glass having a refractive index of 1.5, and the predetermined incidence angle range may be about 25° to 40° in the glass. That is, when the light 404 is incident onto the interface between the substate (e.g., glass) 105 and the air at an incidence angle within the range of 25° to 40° in the glass, the surface reflected light 406 may be a substantially s-polarized light.

FIG. 4B shows a plot of Fresnel transmittance (Ts and Tp) and reflectance (Rs and Rp) of a light versus an incidence angle of the light at a glass-air interface. Ts and Tp represent the Fresnel transmittance for an s-polarized light and a p-polarized light, respectively. Rs and Rp represent the Fresnel reflectance for the s-polarized light and the p-polarized light, respectively. As shown in FIG. 4B, when the incidence angle range of the light is within a range of 25° to 40° in the glass, the surface reflected light is a substantially s-polarized light. As indicated by the curves for the Rs and Rp, within such an incidence angle range, the reflectance for the p-polarized light Rp is substantially zero, whereas the reflectance for the s-polarized light Rs is about 0.1 to about 0.6.

FIG. 4C illustrates an x-z sectional view of an optical device 430 for suppressing the rainbow effect shown in FIG. 4A, according to an embodiment of the present disclosure. As shown in FIG. 4C, the optical device 430 may include the PVH element 100, and a retardation film 405 stacked with the PVH element 100. The PVH element 100 may include the PVH film 115 and the substrate 105. The retardation film 405 may be disposed at a side of the substate 105 facing the eye 360 (e.g., the lower surface of the substate 105 shown in FIG. 4C), and the substate 105 may be disposed between the PVH film 115 and the retardation film 405. In some embodiments, the retardation film 405 may be disposed at the interface between the substate 105 and the air (e.g., the lower surface of the substate 105 shown in FIG. 4C).

For illustrative purposes, FIG. 4C shows that the PVH element 100 and the retardation film 405 are directly coupled to one another without a gap therebetween. In some embodiments, the PVH element 100 and the retardation film 405 may be spaced apart from one another with a gap. In some embodiments, the PVH element 100 and the retardation film 405 may be directly coupled to one another without another optical element disposed therebetween. In some embodiments, the PVH element 100 and the retardation film 405 may be indirectly coupled to one another with another optical element (e.g., a compensation plate) disposed therebetween.

The retardation film 405 may be fabricated based on any suitable materials, such as liquid crystals, polymers, or plastics, etc. The retardation film 405 may function as a polarization controlling or converting element. In some embodiments, the retardation film 405 may include at least one of an A-film, an O-film, or a biaxial film. For discussion purposes, FIG. 4C shows that the area of the retardation film 405 is less than the area of the PVH film 115. In some embodiments, the area of the retardation film 405 may be substantially the same as (or comparable to) the area of the PVH film 115. The retardation film 405 may have a first surface 405-1 that is an interface between the retardation film 405 and the air (e.g., the lower surface of the retardation film 405 shown in FIG. 4C), and a second, opposing surface 405-2 that is an interface between the retardation film 405 and the substate 105 (e.g., the upper surface of the retardation film 405 shown in FIG. 4C). The PVH film 115 may be configured to refract the light 402 that is incident onto the second surface 115-2 as the light 404. The light 404 may propagate through the substate 115 into the retardation film 405 at the second surface 405-2.

As discussed above in connection with FIGS. 4A and 4B, when the incidence angle range of the light 404 is within a range of about 25° to 40° in the glass, the reflected light 406 from the interface between the substate (e.g., glass) 105 and the air (e.g., the lower surface of the substate 105 shown in FIG. 4A) may be a substantially s-polarized light, which propagates toward the PVH film 115 and experiences the Frensel reflection at the interface between the PVH film 115 and the air. Referring to FIG. 4C, in some embodiments, the average refractive index of the retardation film 405 may be substantially the same as the refractive index of the substate 105. Thus, when the incidence angle range of the light 404 is within the range of about 25° to 40° in the retardation film 405, the light 404 may be reflected by the first surface 405-1 into a light 412 that is a substantially s-polarized light. In the embodiment shown in FIG. 4C, the retardation film 405 may be configured to provide a predetermined phase retardation (or predetermined phase retardation profile) to the light 412 reflected from the second surface 405-2 of the retardation film 405 to re-configure, or control the polarization of the light 412.

For example, the retardation film 405 may be configured to convert the light 412 (e.g., s-polarized light) into a light 413 that is a circularly polarized light having a first handedness, while transmitting the light 412. The light 413 may propagate through the substate 105 into the PVH film 115 at the first surface 115-1. The PVH film 115 may be configured to substantially diffract a circularly polarized light having the first handedness, and substantially transmit (with negligible diffraction) a circularly polarized light having a second handedness that is opposite to the first handedness. Thus, the light 413 may be substantially transmitted (with negligible diffraction) by the PVH film 115, and refracted at the second surface 115-2 as a light 414 propagating toward a same side of the PVH film 115 as the light 402. That is, the PVH film 115 may direct the light 413 out of the PVH film 115 into the air from the second surface 115-2. As a result, the eye 360 may not receive the light 414. Thus, the rainbow effect that may otherwise be caused by the Fresnel reflection at the interface (e.g., the second surface 115-2) between the PVH film 115 and the real-world environment (e.g., air) may be significantly reduced.

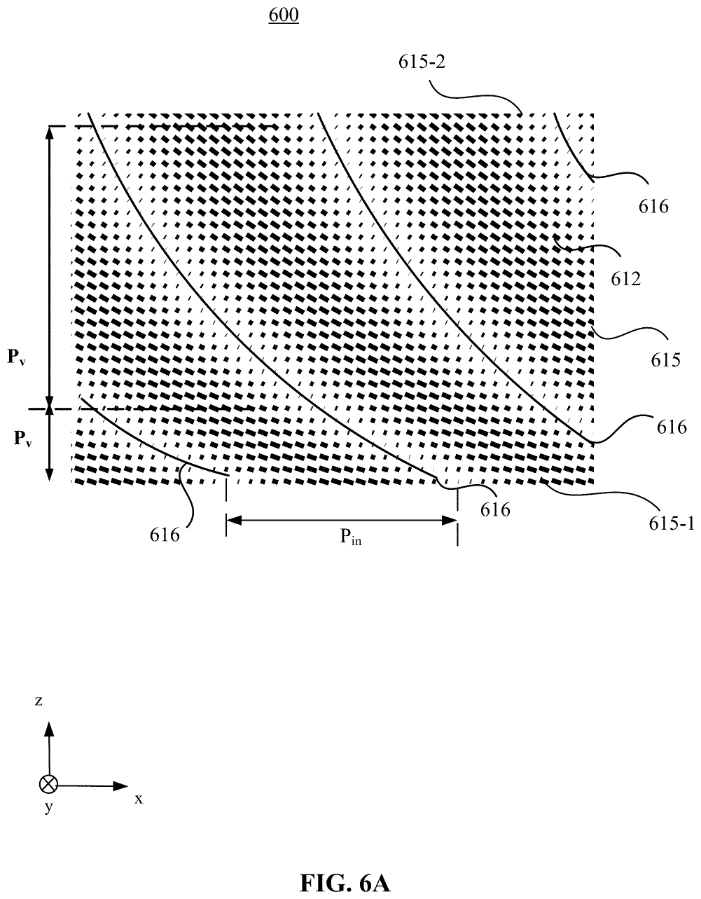

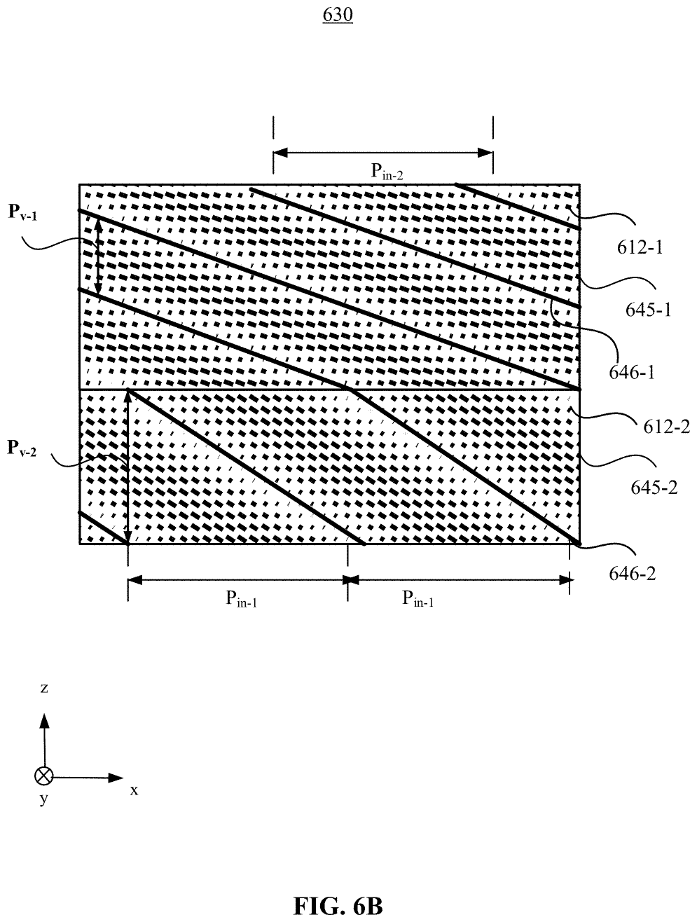

FIG. 5A illustrates a schematic diagram showing a rainbow effect caused by the PVH element 100 shown in FIG. 1A. A real-world light 502 may be incident onto the PVH element 100 from a first side of the PVH element 100 that is opposite to a second side of the PVH element 100 where the eye 360 is located. The rainbow effect may result from a forward diffraction of the light 502 by the PVH film 115 of the PVH element 100. Such a rainbow effect may be referred to as a transmissive rainbow effect for discussion purposes. As shown in FIG. 5A, the real-world light 502 may be incident onto the second surface 115-2 of the PVH film 115. The light 502 may be a visible polychromatic light. When the light 502 substantially satisfies the Bragg condition of the PVH element 100, the PVH element 100 may forwardly diffract the light 502 as a light 504 propagating toward the eye 360, causing a multicolored glare (“rainbow effect”) in a see-through view when the user looks through the PVH element 100.

The inventors have observed that such a transmissive rainbow effect mostly results from the real-world light 502 having a large incidence angle greater than or equal to a third predetermined angle (e.g., 50°, 60°, or 65°, etc.) at the PVH element 100, because such a real-world light 502 may be forwardly diffracted to the eyes 360 by the PVH element 100, causing the rainbow effect in the see-through view. The large incidence angle greater than or equal to the third predetermined angle may be an angle within a third predetermined angle range, such as 50°-80°, 60°-80°, 65°-80°, 70°-80°, 50°-90°, 60°-90°, 65°-90°, 70°-90°, etc. A real-world light 512 having a small incidence angle less than the third predetermined angle (e.g., 50°, 60°, or 65°) at the PVH element 100 may be diffracted in a direction such that a diffracted light 514 is out of user's sight, or out of the FOV 315 of the system including the PVH element 100, and hence may not cause the rainbow effect in the see-through view. For example, the small incidence angle may be an angle that is outside of, and less than a lower limit of, the third predetermined angle range. The third predetermined angle and the third predetermined range may be the same as or different from the first predetermined angle and the first predetermined angle range.

FIGS. 5B and 5C illustrate x-z sectional views of optical devices 530 and 550 for suppressing the rainbow effect shown in FIG. 5A, according to various embodiments of the present disclosure. As shown in FIGS. 5B and 5C, the optical device 530 or 550 may include the PVH element 100 and the optical filter 305 stacked in an optical series. The optical filter 305 may be disposed at a first side of the PVH element 100 opposite to a second side of the PVH element 100 where the eye 360 is located. That is, the optical filter 305 may be disposed at or adjacent the second surface 115-2 of the PVH film 115 in the PVH element 100. For discussion purposes, FIGS. 5B and 5C show that the PVH element 100 and the optical filter 305 are spaced apart from one another with a gap. In some embodiments, the PVH element 100 and the optical filter 305 may be directly coupled to one another without a gap therebetween. In some embodiments, the PVH element 100 and the optical filter 305 may be directly coupled to one another without another optical element disposed therebetween. In some embodiments, the PVH element 100 and the optical filter 305 may be indirectly coupled to one another with another optical element (e.g., a compensation plate) disposed therebetween.

The optical filter 305 may be an angularly selective optical element configured to selectively deflect or transmit an incident light, depending on an incidence angle of the light at the optical filter 305. In the embodiment shown in FIG. 5B, when the incidence angle of the light 502 at the optical filter 305 is greater than or equal to a fourth predetermined angle (e.g., 50°, 60°, or 65°, etc.), the optical filter 305 may backwardly deflect the light 502 back to the real-world environment and away from the eye 360. In some embodiments, the incidence angle of the light 502 may be within a predetermined angle range (also referred to as a fourth predetermined angle range), e.g., 50°-80°, 60°-80°, 65°-80°, 70°-80°, 50°-90°, 60°-90°, 65°-90°, 70°-90°, etc. The fourth predetermined angle may be the same as or different from the second predetermined angle. The fourth predetermined angle range may be the same as or different from the second predetermined angle range. FIG. 5B shows that the optical filter 305 may backwardly deflect the light 502 as a light 506 propagating back to the real-world environment and away from the eye 360. The light 506 may be blocked by the optical filter 305 from being incident onto the PVH element 100. Thus, the forward diffraction of the light 502 caused by the PVH element 100 may be significantly reduced. Accordingly, the rainbow effect in the see-through view may be significantly reduced.

As the incidence angle of the light 512 at the optical filter 305 is less than the fourth predetermined angle (e.g., 50°, 60°, or 65°, etc.), the optical filter 305 may be configured to transmit, with negligible deflection, the light 512 toward the PVH element 100. The PVH element 100 may forwardly diffract the light 512 in a direction as a diffracted light 516 such that the diffracted light 516 is out of user's sight, or out of an FOV 315 of the system including the PVH element 100, which may not cause the rainbow effect in the see-through view.

In the embodiment shown in FIG. 5C, as the incidence angle of the light 502 at the optical filter 305 is greater than or equal to the fourth predetermined angle (e.g., 50°, 60°, or 65°, etc.), the optical filter 305 may be configured to forwardly deflect the light 502 as a light 508 propagating toward the PVH element 100. In some embodiments, the incidence angle of the light 508 at the PVH element 100 may be the same as the deflection angle of the light 508 output from the optical filter 305. The optical filter 305 may be configured, such that the light 508 incident onto the PVH element 100 does not satisfy the Bragg condition of the PVH element 100. Thus, the PVH element 100 may substantially transmit, with negligible diffraction, the light 508 as a light 510. In some embodiments, the light 510 may propagate in a direction such that the light 510 is out of user's sight or out of the FOV 315 of the system. In some embodiments, the light 510 may propagate in a direction such that the light 510 is within the FOV 315 of the system Accordingly, the rainbow effect in the see-through view that may otherwise be caused by the forward diffraction of the PVH element 100 may be significantly reduced.

As the incidence angle of the light 512 at the optical filter 305 is less than the fourth predetermined angle (e.g., 50°, 60°, or 65°, etc.), the optical filter 305 may substantially transmit, with negligible deflection, the light 512 toward the PVH element 100. The PVH element 100 may forwardly diffract the light 512 in a direction such that the diffracted light 516 is out of user's sight, or out of the FOV 315 of a system including the PVH element 100. The light 512 may not cause the rainbow effect in the see-through view.

In the embodiment shown in FIG. 5C, the optical filter 305 may include a transmissive PVH element, e.g., similar to the transmissive PVH element 200 shown in FIG. 2A. The transmissive PVH element is also referred to as 305 for discussion purposes. When the incidence angle of the light 502 at the transmissive PVH element 305 is greater than or equal to the fourth predetermined angle (e.g., 50°, 60°, or 65°, etc.), the transmissive PVH element 305 may substantially forwardly diffract the light 502 as the light 508 propagating toward the PVH element 100. In some embodiments, the parameters of the transmissive PVH element 305 (e.g., the orientations of Bragg planes) may be configured, such that the diffraction angle of the light 508 output from the transmissive PVH element 305 may be configured to be with a predetermined diffraction angle range. For example, in the embodiment shown in FIG. 5C, the Bragg planes (denoted by solid black vertical lines) in the transmissive PVH element 305 may be configured to be substantially perpendicular to the incidence surface of the transmissive PVH element 305. The incidence angle of the light 508 at the PVH element 100 may be configured by configuring the diffraction angle of the light 508 output from the transmissive PVH element 305. In some embodiments, the incidence angle of the light 508 at the PVH element 100 may be the same as the diffraction angle of the light 508 output from the transmissive PVH element 305. In some embodiments, the light 508 incident onto the PVH element 100 may not satisfy the Bragg condition of the PVH element 100. Thus, the PVH element 100 may substantially transmit, with negligible diffraction, the light 508 as the light 510.

The real-world light 512 may be incident onto the transmissive PVH element 305, with an incidence angle less than the fourth predetermined angle (e.g., 50°, 60°, or 65°, etc.). In some embodiments, the real-world light 512 may not satisfied the Bragg condition of the transmissive PVH element 305. Thus, the transmissive PVH element 305 may substantially transmit, with negligible diffraction, the light 512 toward the PVH element 100. The PVH element 100 may diffract the light 512 in a direction such that the diffracted light 516 is out of user's sight, or out of an FOV 315 of the system including the PVH element 100.

In some embodiments, the PVH element 100 may include a single PVH film 115, and the PVH element 100 may be referred to as a single-layer PVH element. In some embodiments, the PVH element 100 may be configured with a uniform vertical pitch Pᵥ and a uniform in-plane pitch Pᵢₙ. The vertical pitch Pᵥ may be defined as a distance along the thickness direction (e.g., the z-axis direction) of the PVH film 115 over which the LC directors of the LC molecules rotate around the helical axis by 180° or the azimuthal angles of the LC molecules vary by 180°. The in-plane pitch Pᵢₙ may be defined as a distance along the in-plane direction (e.g., the x-axis direction) over which the LC directors rotate by 180°. In some embodiments, to increase an operation wavelength spectrum (e.g., 450 nm to 650 nm) within the visible spectrum, the birefringence of the PVH film 115 (or the birefringence of the LC material in the PVH film 115) may be configured with a relatively large value, e.g., about 0.4.

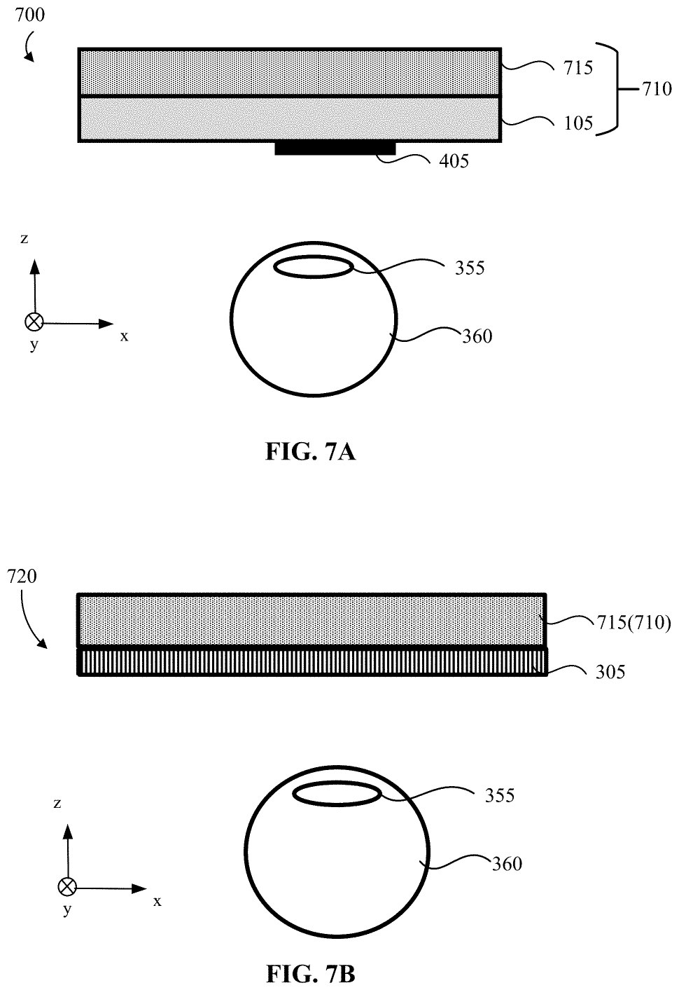

FIG. 6A illustrates an x-z sectional view of an optical device 600 for suppressing the rainbow effect shown in FIG. 5A, according to an embodiment of the present disclosure. The optical device 600 may function as a transmissive or reflective PVH element. For discussion purposes, the optical device 600 may also be referred to as a PVH element 600. As shown in FIG. 6A, the PVH element 600 may be a single-layer PVH element that includes a single PVH film 615. The PVH film 615 may include polymerized (or cross-linked) liquid crystals (“LCs”), polymer-stabilized LCs, photopolymers (e.g., amorphous polymers, liquid crystal (“LC”) polymers, etc.), or any combination thereof. The LCs may include nematic LCs, twist-bend LCs, chiral nematic LCs, smectic LCs, or any combination thereof. FIG. 6A also illustrates an x-z sectional view of an out-of-plane orientational pattern of optically anisotropic molecules (e.g., LC molecules) 612 included in the PVH film 615, according to an embodiment of the present disclosure. As show in FIG. 6A, the LC molecules 612 in the PVH film 615 may be arranged in a 3D orientation pattern having a varying vertical pitch Pᵥ (e.g., the pitch in the thickness direction). For discussion purposes, in the embodiment shown in FIG. 6A, the LC molecules 612 in the PVH film 615 may be aligned with a uniform in-plane pitch Pᵢₙ (e.g., the pitch in a direction in the x-y plane). That is, the orientations of the directors of the LC molecules may have an in-plane orientation pattern corresponding to a grating pattern. In some embodiments, the LC molecules 612 in the PVH film 615 may be aligned with a varying in-plane pitch Pᵢₙ (e.g., the pitch in a direction in the x-y plane). That is, the orientations of the directors of the LC molecules 612 may have an in-plane orientation pattern corresponding to a lens pattern.

In some embodiments, within the volume of the PVH film 615, between a first surface 615-1 and a second surface 615-2 of the PVH film 615, the vertical pitch Pᵥ may be configured to change in a predetermined manner, such as a gradually increasing or decreasing manner, a combination of increasing and decreasing manner, etc. For example, from the first surface 615-1 to the second surface 615-2 of the PVH film 615, the vertical pitch Pᵥ of the PVH film 615 may gradually decrease or increase in a gradient manner. The gradient manner may be a linearly gradient manner, a non-linearly gradient manner, a stepped gradient manner, or a suitable combination thereof. For discussion purposes, in the embodiment shown in FIG. 6A, from the first surface 615-1 to the second surface 615-2 of the PVH film 615, the vertical pitch Pᵥ of the PVH film 615 may gradually increase in a stepped gradient manner. Bragg planes 616 within the volume of the PVH film 615 may be configured to have continuous curved shapes, as schematically indicated by curved lines in FIG. 6C. In other words, the Bragg planes 616 may be curved planes, and may not be parallel to one another. Although not shown, in some embodiments, from the first surface 615-1 to the second surface 615-2 of the PVH film 615, the vertical pitch Pᵥ of the PVH film 615 may first increase (or decrease), then decrease (or increase), etc.

In some embodiments, the birefringence of the PVH film 615 (or the birefringence of the LC material in the PVH film 615) in the PVH element 600 may be configured to be less than the birefringence of the PVH film 115 (or the birefringence of the LC material in the PVH film 115) in the PVH element 100 shown in FIG. 5A. For example, the birefringence of the PVH film 615 in the PVH element 600 may be equal to or less than a predetermined value, e.g., 0.2, 0.1, etc. In some embodiments, the diffraction efficiency of a PVH element may decrease as the birefringence of the PVH element deceases. Thus, the diffraction efficiency of the PVH element 600 shown in FIG. 6A may be less than the diffraction efficiency of the PVH element 100 shown in FIG. 5A. Accordingly, the rainbow effect caused by the forward diffraction of the PVH element 600 shown in FIG. 6A may be weaker than the rainbow effect caused by the forward diffraction of the PVH element 100 shown in FIG. 5A. In some embodiments, the variation of the vertical pitch Pᵥ (e.g., the pitch in the thickness direction) of the PVH element 600 shown in FIG. 6A may be configured, such that the PVH element 600 may have a broad operation wavelength spectrum (e.g., 450 nm to 650 nm) that may be similar to the operation wavelength spectrum of the PVH element 100 shown in FIG. 5A.

Although not shown, in some embodiments, the PVH element 600 may include a plurality of PVH films, at least one of which may be configured with a varying vertical pitch Pᵥ. Such a PVH element 600 may be referred to as a multi-layer PVH element. In some embodiments, the PVH element 600 may include a plurality of PVH films, each of which may be configured with a varying vertical pitch Pᵥ. In some embodiments, the variation of the vertical pitch Pᵥ may be substantially the same, or the variations of the vertical pitches Pᵥ in at least two PVH films may be different from one another. In some embodiments, the birefringence of each PVH film in the PVH element 600 may be equal to or less than the predetermined value, e.g., 0.2, 0.1, etc. The variations of the vertical pitches Pᵥ in the PVH element 600 may be configured, such that the PVH element 600 may have a broad operation wavelength spectrum (e.g., 450 nm to 650 nm) that may be similar to the operation wavelength spectrum of the PVH element 100 shown in FIG. 5A.

FIG. 6B illustrates an x-z sectional view of a PVH element 630 for suppressing the rainbow effect shown in FIG. 5A, according to an embodiment of the present disclosure. The optical device 630 may function as a transmissive or reflective PVH element. For discussion purposes, the optical device 630 may also be referred to as a PVH element 630. As shown in FIG. 6C, the PVH element 630 may include two PVH films: a first PVH film 645-1 and a second PVH film 645-2. The PVH element 630 may be referred to as a two-layer PVH element. FIG. 6B also illustrates an x-z sectional view of out-of-plane orientational patterns of optically anisotropic molecules (e.g., LC molecules) 612-1 included in the first PVH film 645-1 and optically anisotropic molecules (e.g., LC molecules) 612-2 included in the second PVH film 645-2, according to an embodiment of the present disclosure.

The LC molecules 612-1 in the first PVH film 645-1 may be arranged in a 3D orientation pattern having a first vertical pitch Pᵥ₋₁ and a first in-plane pitch Pᵢₙ₋₁. The LC molecules 612-2 in the second PVH film 645-2 may be arranged in a 3D orientation pattern having a second vertical pitch Pᵥ₋₂ and a second in-plane pitch Pᵢₙ₋₂. The LC molecules 612-1 in the first PVH film 645-1 and the LC molecules 612-2 in the second PVH film 645-2 may be configured to have substantially the same in-plane orientation pattern. For discussion purposes, in the embodiment shown in FIG. 6B, the LC molecules 612-1 in the first PVH film 645-1 and the LC molecules 612-2 in the second PVH film 645-2 may be aligned with uniform in-plane pitches Pᵢₙ. That is, the orientations of the directors of the LC molecules 612-1 and 612-2 may have in-plane orientation patterns corresponding to grating patterns. For example, the first in-plane pitch Pᵢₙ₋₁ and the second in-plane pitch Pᵢₙ₋₂ may be substantially the same. In some embodiments, the LC molecules 612-1 in the first PVH film 645-1 and the LC molecules 612-2 in the second PVH film 645-2 may be aligned with varying in-plane pitches Pᵢₙ. That is, the orientations of the directors of the LC molecules 612-1 and 612-2 may have in-plane orientation patterns corresponding to lens patterns.

The first vertical pitch Pᵥ₋₁ may be configured to be different from (e.g., greater than or less than) the second vertical pitch Pᵥ₋₂. For discussion purposes, FIG. 6B shows that the first vertical pitch Pᵥ₋₁ is less than the second vertical pitch Pᵥ₋₂. In some embodiments, a ratio between the first vertical pitch Pᵥ₋₁ and the second vertical pitch Pᵥ₋₂ may be within a suitable range or may be a suitable number, e.g., any sub-range or any number within the range of 0.2-0.8. In one embodiment, the first vertical pitch Pᵥ₋₁ may be about half of the second vertical pitch Pᵥ₋₂. The slant angle α of a PVH is defined as α=90°−β, where β=arctan (Pᵥ/Pᵢₙ). The slant angle α of the first PVH film 645-1 may be configured to be smaller than the slant angle α of the second PVH film 645-2. In some embodiments, the PVH films 645-1 and 645-2 may be configured to have the same polarization selectivity. For example, the PVH films 645-1 and 645-2 may be configured to substantially diffract an RHCP (or LHCP) light, and substantially transmit an LHCP (or RHCP) light.

In the embodiment shown in FIG. 6B, the first PVH film 645-1 may be configured to have a relatively large thickness, and the second PVH film 645-2 may be configured to have a relatively small thicknesses. In some embodiments, a ratio between the thickness of the second PVH film 645-2 and the thickness of the first PVH film 645-1 may be less than a predetermined percentage, for example, 5%, 10%, 15%, 20%, 25%, 30%, 35%, 40%, 45%, or 50%. In some embodiments, the first PVH film 645-1 and the second PVH film 645-2 may be configured to have the substantially same thickness.

Bragg planes 646-1 and 646-2 within a volume of the first PVH film 645-1 and the second PVH film 645-2 are schematically indicated by inclined lines within the respective PVH film. The Bragg planes 646-1 within the volume of the first PVH film 645-1 may have continuous planar shapes, titled with respect to the thickness direction of the first PVH film 645-1. The Bragg planes 646-2 within the volume of the second PVH film 645-2 may have continuous planar shapes, titled with respect to the thickness direction of the second PVH film 645-2. The Bragg planes 646-1 and the Bragg planes 646-2 may not be continuous. The Bragg planes 646-1 and the Bragg planes 646-2 may form the Bragg planes of the PVH element 630. The Bragg planes of the PVH element 630 may be discontinuous.

In some embodiments, the birefringences of the PVH films 645-1 and 645-2 in the PVH element 630 may be configured to be less than the birefringence of the PVH film 115 in the PVH element 100 shown in FIG. 5A. For example, the birefringences of the PVH films 645-1 and 645-2 in the PVH element 630 may be equal to or less than the predetermined value, e.g., 0.2, 0.1, etc. In some embodiments, the diffraction efficiency of a PVH element may decrease as the birefringence of the PVH element deceases. Thus, the diffraction efficiency of the PVH element 630 shown in FIG. 6B may be lower than the diffraction efficiency of the PVH element 100 shown in FIG. 5A. Thus, the rainbow effect caused by the forward diffraction of the PVH element 630 shown in FIG. 6B may be weaker than the rainbow effect caused by the forward diffraction of the PVH element 100 shown in FIG. 5A. In some embodiments, the vertical pitches Pᵥ₋₁ and Pᵥ₋₂ of the PVH element 630 shown in FIG. 6B may be configured, such that the PVH element 630 may be configured to have a broad operation wavelength spectrum (e.g., 450 nm to 650 nm) that may be similar to the operation wavelength spectrum of the PVH element 100 shown in FIG. 5A.

Although not shown, in some embodiments, the PVH element 630 may include more than two PVH films. Such a PVH element 630 may be referred to as a multi-layer PVH element. LC molecules in each PVH film may be arranged in a 3D orientation pattern having a vertical pitch Pᵥ and an in-plane pitch Pᵢₙ. The LC molecules in the PVH films may be aligned in the same in-plane orientation pattern. For example, the in-plane pitches Pᵢₙ of the PVH films may be uniform and substantially the same. The vertical pitches Pᵥ in at least two PVH films may be different from one other. In some embodiments, the thicknesses of the PVH films may be substantially the same. In some embodiments, the thicknesses of at least two of the PVH films may be different from one other. In some embodiments, the birefringence of each PVH film in the PVH element 630 may be equal to or less than the predetermined value, e.g., 0.2, 0.1, etc. The vertical pitches Pᵥ in the PVH element 630 may be configured, such that the PVH element 630 may have a broad operation wavelength spectrum (e.g., 450 nm to 650 nm) that may be similar to the operation wavelength spectrum of the PVH element 100 shown in FIG. 5A.

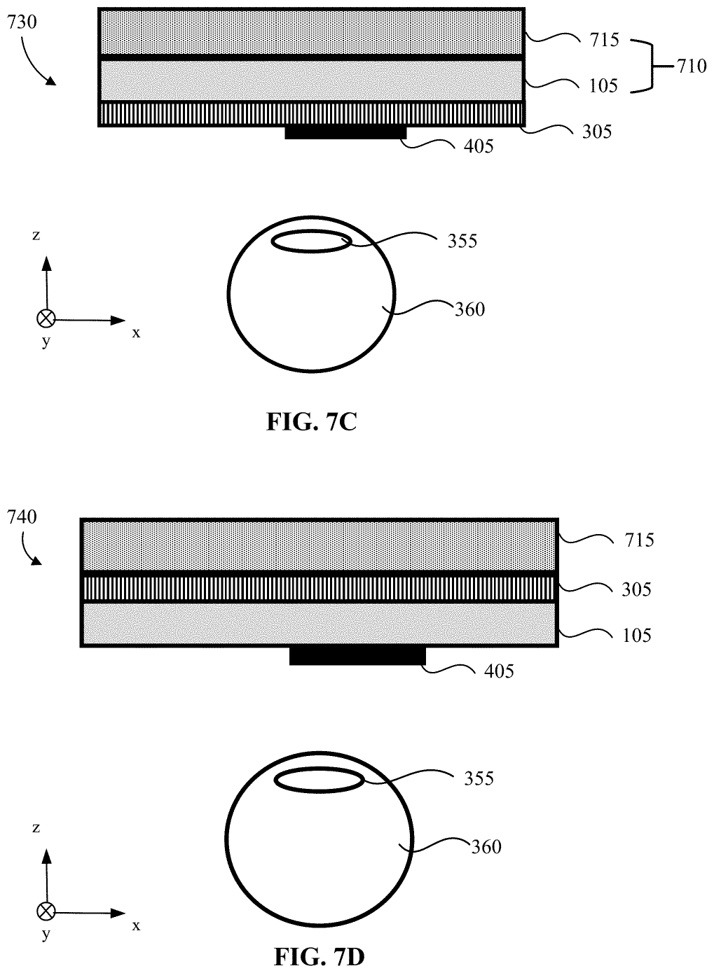

In the present disclosure, features of the disclosed embodiments may be combined in a same embodiment for suppressing various rainbow effects illustrated in FIG. 3A, FIG. 4A, and/or FIG. 5A. FIGS. 7A-7F illustrate x-z sectional views of optical devices for suppressing rainbow effects illustrated in FIG. 3A, FIG. 4A, and/or FIG. 5A, according to various embodiments of the present disclosure. The optical devices shown in FIGS. 7A-7F may include elements, structures, and/or functions that are the same as or similar to those included in the optical devices shown in one or more of FIGS. 1A-6B. Detailed descriptions of the same or similar elements, structures, and/or functions may refer to the above descriptions rendered in connection with one or more of FIGS. 1A-6B.

In the embodiment shown in FIG. 7A, an optical device 700 may include a PVH film stack 715 including one or more PVH films, the substate 105, and the retardation film 405 arranged in an optical series. The substate 105 may be disposed between the PVH film stack 715 and the retardation film 405. In some embodiments, the combination of the PVH film stack 715 and the substate 105 may be referred to as a PVH element 710. The retardation film 405 may be disposed at a side of the substate 105 (or the PVH element 710) facing the eye 360. In some embodiments, the PVH film stack 715 may include at least one PVH film configured with a varying vertical pitch, e.g., similar to the PVH film 615 shown in FIG. 6A. In some embodiments, the PVH film stack 715 may include at least two PVH films configured with different vertical pitches, e.g., similar to the PVH films 645-1 and 645-2 shown in FIG. 6B.

In the embodiment shown in FIG. 7B, an optical device 720 may include the PVH film stack 715 (or the PVH element 710) and the optical filter 305 arranged in an optical series. In some embodiments, the PVH film stack 715 may include at least one PVH film configured with a varying vertical pitch, e.g., similar to the PVH film 615 shown in FIG. 6A. In some embodiments, the PVH film stack 715 may include at least two PVH films configured with different vertical pitches, e.g., similar to the PVH films 645-1 and 645-2 shown in FIG. 6B. The optical filter 305 may be disposed at a side of the PVH film stack 715 facing the eye 360 (as shown in FIG. 7B), or may be disposed at the other side of the PVH film stack 715 opposite to the side where the eye 360 is located (not shown).

In the embodiment shown in FIG. 7C, an optical device 730 may include the PVH film stack 715, the substate 105, the optical filter 305, and the retardation film 405 arranged in an optical series. In some embodiments, the PVH film stack 715 may include at least one PVH film configured with a varying vertical pitch, e.g., similar to the PVH film 615 shown in FIG. 6A. In some embodiments, the PVH film stack 715 may include at least two PVH films configured with different vertical pitches, e.g., similar to the PVH films 645-1 and 645-2 shown in FIG. 6B. The substate 105 may be disposed between the PVH film stack 715 and the retardation film 405. As shown in FIG. 7C, the substrate 105 is also disposed between the PVH film stack 715 and the optical filter 305. In some embodiments, the combination of the PVH film stack 715 and the substate 105 may be referred to as a PVH element 710. In the embodiment shown in FIG. 7C, the optical filter 305 may be disposed at a side of the PVH element 710 facing the eye 360, and disposed between the substate 105 and the retardation film 405. Although not shown, in some embodiments, the optical filter 305 may be disposed at another side of the PVH element 710 opposite to the side where the eye 360 is located, and the PVH element 710 may be disposed between the optical filter 305 and the retardation film 405.

In the embodiment shown in FIG. 7D, an optical device 740 may include the PVH film stack 715, the optical filter 305, the substate 105, and the retardation film 405 arranged in an optical series. In some embodiments, the PVH film stack 715 may include at least one PVH film configured with a varying vertical pitch, e.g., similar to the PVH film 615 shown in FIG. 6A. In some embodiments, the PVH film stack 715 may include at least two PVH films configured with different vertical pitches, e.g., similar to the PVH films 645-1 and 645-2 shown in FIG. 6B. The substate 105 may be disposed between the PVH film stack 715 and the retardation film 405. In the embodiment shown in FIG. 7D, the optical filter 305 may be disposed at a side of the PVH film stack 715 facing the eye 360, and disposed between the PVH film stack 715 and the substate 105.

In the embodiment shown in FIG. 7E, an optical device 750 may include the PVH film 115, the substate 105, the optical filter 305, and the retardation film 405 arranged in an optical series. The substate 105 may be disposed between the PVH film 115 and the retardation film 405. As shown in FIG. 7E, the substrate 105 is also disposed between the PVH film 115 and the optical filter 305. In some embodiments, the combination of the PVH film 115 and the substate 105 may be referred to as the PVH element 100. In the embodiment shown in FIG. 7E, the optical filter 305 may be disposed at a side of the PVH element 100 facing the eye 360, and disposed between the substate 105 and the retardation film 405. Although not shown, in some embodiments, the optical filter 305 may be disposed at another side of the PVH element 100 that is opposite to the side where the eye 360 is located, and the PVH element 110 may be disposed between the optical filter 305 and the retardation film 405.

In the embodiment shown in FIG. 7F, an optical device 760 may include the PVH film 115, the optical filter 305, the substate 105, and the retardation film 405 arranged in an optical series. The substate 105 may be disposed between the PVH film 115 and the retardation film 405. In the embodiment shown in FIG. 7F, the optical filter 305 may be disposed at a side of the PVH film 115 facing the eye 360, and disposed between the PVH film 115 and the substate 105.

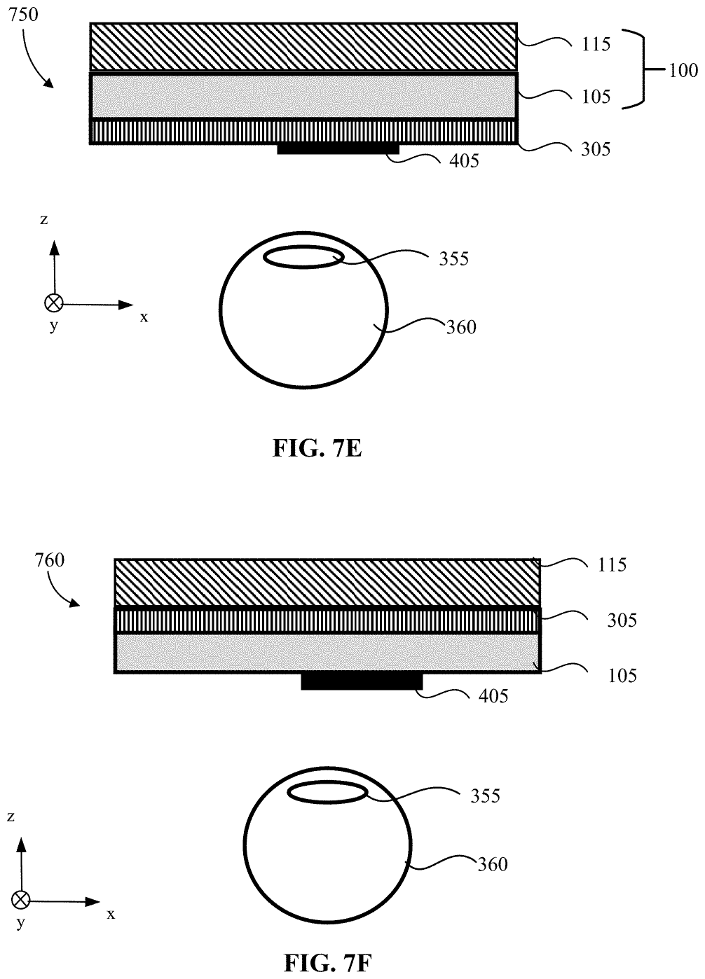

The disclosed optical devices for suppressing the rainbow effect may be implemented in various systems for augmented reality (“AR”), virtual reality (“VR”), and/or mixed reality (“MR”) applications, e.g., near-eye displays (“NEDs”), head-up displays (“HUDs”), head-mounted displays (“HMDs”), smart phones, laptops, televisions, vehicles, etc. Some exemplary applications in AR, VR, or MR fields or some combinations thereof will be explained below. FIG. 8 illustrates a schematic diagram of a light guide display system 800, according to an embodiment of the present disclosure. The light guide display system 800 may be a part of a system (e.g., an NED, an HUD, an HMD, a smart phone, a laptop, or a television, etc.) for VR, AR, and/or MR applications. The light guide display system 800 may include image display components configured to project an image light (forming a computer-generated virtual image) into a display window in a field of view (“FOV”). The light guide display system 800 may include one or more disclosed optical devices for suppressing the rainbow effect in the see-through views.

As shown in FIG. 8, the light guide display system 800 may include a light source assembly 805, a light guide 810, and a controller 817. The controller 817 may be configured to perform various controls, adjustments, or other functions or processes described herein. The light source assembly 805 may include a light source 820 and a light conditioning system 825. In some embodiments, the light source 820 may be a light source configured to generate a coherent or partially coherent light. The light source 820 may include, e.g., a laser diode, a vertical cavity surface emitting laser, a light emitting diode, or a combination thereof. In some embodiments, the light source 820 may be a display panel, such as a liquid crystal display (“LCD”) panel, a liquid-crystal-on-silicon (“LCoS”) display panel, an organic light-emitting diode (“OLED”) display panel, a micro light-emitting diode (“micro-LED”) display panel, a digital light processing (“DLP”) display panel, a laser scanning display panel, or a combination thereof. In some embodiments, the light source 820 may be a self-emissive panel, such as an OLED display panel or a micro-LED display panel. In some embodiments, the light source 820 may be a display panel that is illuminated by an external source, such as an LCD panel, an LCoS display panel, or a DLP display panel. Examples of an external source may include a laser, an LED, an OLED, or a combination thereof. The light conditioning system 825 may include one or more optical components configured to condition the light from the light source 820. For example, the controller 817 may control the light conditioning system 825 to condition the light from the light source 820, which may include, e.g., transmitting, attenuating, expanding, collimating, and/or adjusting orientation of the light.

The light source assembly 805 may generate an image light 830 and output the image light 830 to an in-coupling element 835 disposed at a first portion of the light guide 810. In some embodiments, the in-coupling element 835 may couple the image light 830 into a total internal reflection (“TIR”) path inside the light guide 810. The image light 830 may propagate inside the light guide 810 through TIR along the TTR path, toward an out-coupling element 845 located at a second portion of the light guide 810. The first portion and the second portion may be located at different portions of the light guide 810. The out-coupling element 845 may be configured to couple the image light 830 out of the light guide 810. For example, the out-coupling element 845 may be configured to couple the image light 830 out of the light guide 810 as an image light 832 propagating toward an eye-box region 855. In some embodiments, the light guide display system 800 may expand and direct the image light 830 to an exit pupil 857 positioned in the eye-box region 855 of the light guide display system 800. The exit pupil 857 may be a location where the eye 360 is positioned in the eye-box region 855.

The light guide 810 may include a first surface or side 810-1 facing the real-world environment and an opposing second surface or side 810-2 facing the eye-box region 855. Each of the in-coupling element 835 and the out-coupling element 845 may be disposed at the first surface 810-1 or the second surface 810-2 of the light guide 810. In some embodiments, as shown in FIG. 8, the in-coupling element 835 may be disposed at the second surface 810-2 of the light guide 810, and the out-coupling element 845 may be disposed at the first surface 810-1 of the light guide 810. In some embodiments, the in-coupling element 835 may be disposed at the first surface 810-1 of the light guide 810. In some embodiments, the out-coupling element 845 may be disposed at the second surface 810-2 of the light guide 810. In some embodiments, both of the in-coupling element 835 and the out-coupling element 845 may be disposed at the first surface 810-1 or the second surface 810-2 of the light guide 810. In some embodiments, the in-coupling element 835 or the out-coupling element 845 may be integrally formed as a part of the light guide 810 at the corresponding surface. In some embodiments, the in-coupling element 835 or the out-coupling element 845 may be separately formed, and may be disposed at (e.g., affixed to) the corresponding surface.

In some embodiments, each of the in-coupling element 835 and the out-coupling element 845 may have a designed operating wavelength band that includes at least a portion of the visible wavelength band. In some embodiments, the designed operating wavelength band of each of the in-coupling element 835 and the out-coupling element 845 may not include the IR wavelength band. For example, each of the in-coupling element 835 and the out-coupling element 845 may be configured to deflect a visible light, and transmit an IR light without a deflection or with negligible deflection.

In some embodiments, each of the in-coupling element 835 and the out-coupling element 845 may include one or more diffraction gratings, one or more cascaded reflectors, one or more prismatic surface elements, and/or an array of holographic reflectors, or any combination thereof. In some embodiments, each of the in-coupling element 835 and the out-coupling element 845 may include one or more diffraction gratings, such as a surface relief grating, a volume hologram, a polarization selective grating, a polarization volume hologram (“PVH”) grating, a metasurface grating, or any combination thereof. In some embodiments, a period of the diffraction grating included in the in-coupling element 835 may be configured to enable TIR of the image light 830 within the light guide 810. In some embodiments, a period of the diffraction grating included in the out-coupling element 845 may be configured to couple the image light 830 propagating inside the light guide 810 through TIR out of the light guide 810 via diffraction.

The light guide 810 may include one or more materials configured to facilitate the total internal reflection of the image light 830. The light guide 810 may include, for example, a plastic, a glass, and/or polymers. The light guide 810 may have a relatively small form factor. The light guide 810 coupled with the in-coupling element 835 and the out-coupling element 845 may also function as an image combiner (e.g., AR or MR combiner). The light guide 810 may combine the image light 832 representing a virtual image and a light 834 from the real-world environment (or a real-world light 834), such that the virtual image may be superimposed with real-world images. With the light guide display system 800, the physical display and electronics may be moved to a side of a front body of an NED. A substantially fully unobstructed view of the real-world environment may be achieved, which enhances the AR or MR user experience.

In some embodiments, the out-coupling element 845 may include one or more PVH elements, and the light guide display system 800 may include one or more disclosed optical devices for suppressing any rainbow effect that might be introduced by the PVH elements. The optical devices may be, for example, the optical device 330 shown in FIG. 3B, the optical device 350 shown in FIG. 3C, the optical device 430 shown in FIG. 4C, the optical device 530 shown in FIG. 5B, the optical device 550 shown in FIG. 5C, the optical device 600 shown in FIG. 6A, the optical device 630 shown in FIG. 6B, the optical device 700 shown in FIG. 7A, the optical device 720 shown in FIG. 7B, the optical device 730 shown in FIG. 7C, the optical device 740 shown in FIG. 7D, the optical device 750 shown in FIG. 7E, or the optical device 760 shown in FIG. 7F, etc.

For discussion purposes, FIG. 8 shows that the out-coupling element 845 may include a PVH film stack 815 including one or more PVH films, which may substantially backwardly diffract a circularly polarized light having a predetermined handedness, and substantially transmit (with negligible diffraction) a circularly polarized light having a handedness that is opposite to the predetermined handedness. In some embodiments, the PVH film stack 815 may include at least one PVH film configured with a varying vertical pitch, e.g., similar to the PVH film 615 shown in FIG. 6A. In some embodiments, the PVH film stack 815 may include at least two PVH films configured with different vertical pitches, e.g., similar to the PVH films 645-1 and 645-2 shown in FIG. 6B. In some embodiments, the PVH film stack 815 may include at least one PVH film configured with a uniform vertical pitch, e.g., similar to the PVH film 115 shown in FIGS. 1A-1G. The light guide 810 may also function as a substate at which the PVH film stack 815 is disposed. The light guide display system 800 may also include the retardation film 405 disposed at the second surface 810-2 of the light guide 810. The light guide 810 may be disposed between the PVH film stack 815 and the retardation film 405. In the embodiment shown in FIG. 8, the arrangement of the PVH film stack 815, the light guide 810, and the retardation film 405 may be similar to that shown in FIG. 4C or FIG. 7A.

In some embodiments, although not shown, the light guide display system 800 may also include the optical filter 305. In some embodiments, the optical filter 305 may be disposed at the second surface 810-2 of the light guide 810, and disposed between the retardation film 405 and the light guide 810. In some embodiments, the optical filter 305 may be disposed at the second surface 810-2 of the light guide 810, and the retardation film 405 may be disposed between the optical filter 305 and the light guide 810. In some embodiments, the optical filter 305 may be disposed at the first surface 810-1 of the light guide 810, and disposed between the PVH film stack 815 and the light guide 810.

In some embodiments, the out-coupling element 845 may be disposed at the second surface 810-2 of the light guide 810. The PVH film stack 815 may substantially forwardly diffract a circularly polarized light having a predetermined handedness, and substantially transmit (with negligible diffraction) a circularly polarized light having a handedness that is opposite to the predetermined handedness. In some embodiments, the retardation film 405 may be disposed at the first surface 810-1 of the light guide 810. That is, the light guide 810 may be disposed between the retardation film 405 and the PVH film stack 815. In some embodiments, the optical filter 305 may be disposed at the second surface 810-2 of the light guide 810, and disposed between the light guide 810 and the PVH film stack 815. In some embodiments, the optical filter 305 may be disposed at the first surface 810-1 of the light guide 810, and disposed between the light guide 810 and the retardation film 405. In some embodiments, the optical filter 305 may be disposed at the first surface 810-1 of the light guide 810, and the retardation film 405 may be disposed between the light guide 810 and the optical filter 305.

As discussed above, in a conventional light guide display system, a visible polychromatic light from a real-world environment may be diffracted and/or reflected by diffractive structures included in an out-coupling element, resulting in rainbow effects in see-through views when the user wearing the NED looks at a bright light source from certain angles. In the present disclosure, through implementing the disclosed optical devices in the light guide display system 800, the rainbow effects in the see-through views, which may be caused by the diffraction and/or reflection of the visible polychromatic light from the real-world environment and/or the diffraction of a visible polychromatic light from the real world environment at a side of the user (not shown), may be significantly reduced. Thus, the image quality of the see-through views may be significantly improved.

In some embodiments, the light guide 810 may include additional elements configured to redirect, fold, and/or expand the pupil of the light source assembly 805. For example, in some embodiments, the light guide display system 800 may include a redirecting element (not shown) coupled to the light guide 810, and configured to redirect the image light 830 to the out-coupling element 845, such that the image light 830 is coupled out of the light guide 810 by the out-coupling element 845. In some embodiments, the redirecting element may be arranged at a location of the light guide 810 opposing the location of the out-coupling element 845. For example, in some embodiments, the redirecting element may be integrally formed as a part of the light guide 810 at the corresponding surface. In some embodiments, the redirecting element may be separately formed and disposed at (e.g., affixed to) the corresponding surface of the light guide 810.

In some embodiments, the redirecting element and the out-coupling element 845 may have a similar structure. In some embodiments, the redirecting element may include one or more diffraction gratings, one or more cascaded reflectors, one or more prismatic surface elements, an array of holographic reflectors, or any combination thereof. In some embodiments, the redirecting element may include one or more diffraction gratings, such as a surface relief grating, a volume hologram, a polarization selective grating, a polarization volume hologram, a metasurface grating, or any combination thereof. In some embodiments, the redirecting element may include a PVH film stack including one or more PVH films. The rainbow effects that may be introduced by the redirecting element may be reduced following the same mechanisms and design principles disclosed herein for reducing the rainbow effects that may be caused by the out-coupling element 845. In some embodiments, multiple functions, e.g., redirecting, folding, and/or expanding the pupil of the light generated by the light source assembly 805 may be combined into a single element, e.g., the out-coupling element 845. In such embodiments, the redirecting element may be omitted.

In some embodiments, the light guide display system 800 may include a plurality of light guides 810 disposed in a stacked configuration (not shown in FIG. 8). At least one (e.g., each) of the plurality of light guides 810 may be coupled with or include one or more diffractive elements (e.g., in-coupling element, out-coupling element, and/or redirecting element), which may be configured to direct the image light 830 toward the eye 360. In some embodiments, the plurality of light guides 810 disposed in the stacked configuration may be configured to output an expanded polychromatic image light (e.g., a full-color image light). In some embodiments, the light guide display system 800 may include one or more light source assemblies 805 and/or one or more light guides 810. In some embodiments, at least one (e.g., each) of the light source assemblies 805 may be configured to emit a monochromatic image light of a specific wavelength band corresponding to a primary color (e.g., red, green, or blue) and a predetermined FOV (or a predetermined portion of an FOV).

In some embodiments, the light guide display system 800 may include three different light guides 810 configured to deliver component color images (e.g., primary color images) by in-coupling and subsequently out-coupling, e.g., red, green, and blue lights, respectively, in any suitable order. In some embodiments, the light guide display system 800 may include two different light guides configured to deliver component color images (e.g., primary color images) by in-coupling and subsequently out-coupling, e.g., a combination of red and green lights, and a combination of green and blue lights, respectively, in any suitable order. In some embodiments, at least one (e.g., each) of the light source assemblies 805 may be configured to emit a polychromatic image light (e.g., a full-color image light). The relative positions of the eye 360 and the light source assembly 805 shown in FIG. 8 are for illustrative purposes. In some embodiments, the eye 360 and the light source assembly 805 may be disposed at different sides of the light guide 810.

The configuration of the light guide display system 800 shown in FIG. 8 is used as an example display system in illustrating and explaining the operation principles of reducing the rainbow effect that may be caused by a PVH element. The operation principles of using any disclosed optical devices to reduce the rainbow effect and enhance the image quality of see-through views may be applicable to any suitable display system including one or more PVH elements, other than the disclosed light guide display system 800 shown in FIG. 8. In some embodiments, PVH elements included in NEDs, HUDs, and HMDs for AR and/or MR applications may diffract, refract, and/or reflect a visible monochromatic light from the real-world environment, causing an undesirable light spot in a see-through view, when a user wearing the NED, HUD, or HMD looks at a bright light source from certain angles. In some embodiments, the brightness of the undesirable light spot in see-through views may be reduced or suppressed following the mechanisms and design principles disclosed herein for reducing the rainbow effects that may be caused by the PVH elements.

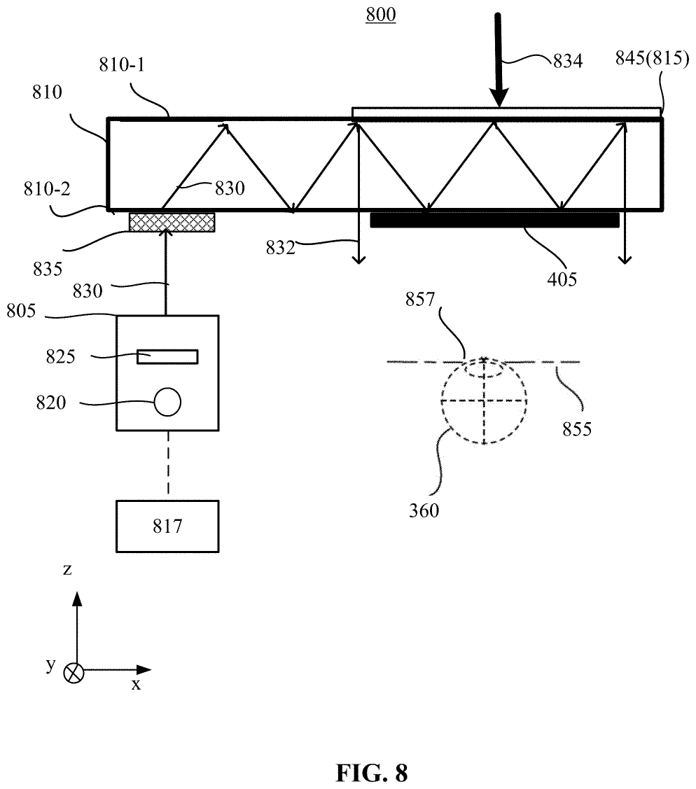

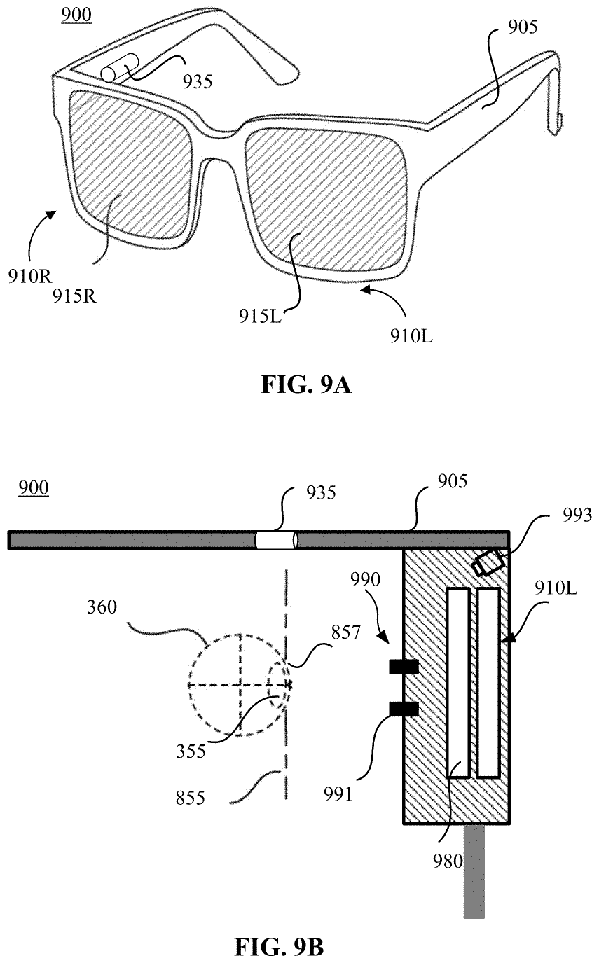

FIG. 9A illustrates a schematic diagram of a near-eye display (“NED”) 900 according to an embodiment of the disclosure. FIG. 9B is a cross-sectional view of half of the NED 900 shown in FIG. 9A according to an embodiment of the disclosure. For purposes of illustration, FIG. 9B shows the cross-sectional view associated with a left-eye display system 910L. The NED 900 may include a controller (not shown), which may be similar to other controllers shown in other figures. The NED 900 may include a frame 905 configured to mount to a user's head. The frame 905 is merely an example structure to which various components of the NED 900 may be mounted. Other suitable type of fixtures may be used in place of or in combination with the frame 905. The NED 900 may include right-eye and left-eye display systems 910R and 910L mounted to the frame 905. The NED 900 may function as a VR device, an AR device, an MR device, or any combination thereof. In some embodiments, when the NED 900 functions as an AR or an MR device, the right-eye and left-eye display systems 910R and 910L may be entirely or partially transparent from the perspective of the user, which may provide the user with a view of a surrounding real-world environment. In some embodiments, when the NED 900 functions as a VR device, the right-eye and left-eye display systems 910R and 910L may be opaque to block the light from the real-world environment, such that the user may be immersed in the VR imagery based on computer-generated images.

The left-eye and right-eye display systems 910L and 910R may include image display components configured to project computer-generated virtual images into left and right display windows 915L and 915R in a field of view (“FOV”). The right-eye and left-eye display systems 910R and 910L may be any suitable display systems. In some embodiments, the right-eye and left-eye display systems 910R and 910L may include one or more disclosed optical devices. In some embodiments, the right-eye and left-eye display systems 910R and 910L may include one or more optical systems (e.g., display systems) disclosed herein, such as the light guide display system 800 shown in FIG. 8. For illustrative purposes, FIG. 9A shows that the left-eye display systems 910L may include a light source assembly (e.g., a projector) 935 coupled to the frame 905 and configured to generate an image light representing a virtual image.

In some embodiments, as shown in FIG. 9B, the left-eye display systems 910L may also include a viewing optical system 980 and an object tracking system 990 (e.g., eye tracking system and/or face tracking system). The viewing optical system 980 may be configured to guide the image light output from the left-eye display system 910L to the exit pupil 857. The exit pupil 857 may be a location where the eye pupil 355 of the eye 360 of the user is positioned in the eye-box region 855 of the left-eye display system 910L. For example, the viewing optical system 980 may include one or more optical elements configured to, e.g., correct aberrations in an image light output from the left-eye display systems 910L, magnify an image light output from the left-eye display systems 910L, or perform another type of optical adjustment of an image light output from the left-eye display systems 910L. Examples of the one or more optical elements may include an aperture, a Fresnel lens, a convex lens, a concave lens, a filter, any other suitable optical element that affects an image light, or a combination thereof.

The object tracking system 990 may include an IR light source 991 configured to illuminate the eye 360 and/or the face, and an optical sensor 993 (e.g., a camera) configured to receive the IR light reflected by the eye 360 and generate a tracking signal relating to the eye 360 (e.g., an image of the eye 360). In some embodiments, the object tracking system 990 may include one or more disclosed optical devices disclosed herein. In some embodiments, the NED 900 may include an adaptive dimming element that may dynamically adjust the transmittance of lights reflected by real-world objects, thereby switching the NED 900 between a VR device and an AR device or between a VR device and an MR device. In some embodiments, along with switching between the AR/MR device and the VR device, the adaptive dimming element may be used in the AR and/MR device to mitigate differences in brightness of lights reflected by real-world objects and virtual image lights.

In accordance with an embodiment of the present disclosure, a device is provided. The device includes a diffraction element and an optical filter stacked with the diffraction element. The optical filter is configured to backwardly deflect a first light from a real-world environment incident onto the optical filter at a first incidence angle greater than or equal to a predetermined angle to block the first light from being incident onto the diffraction element. The optical filter is also configured to transmit a second light from the real-world environment incident onto the optical filter at a second incidence angle less than the predetermined angle toward the diffraction element.

In accordance with an embodiment of the present disclosure, a device is provided. The device includes a diffraction element and an optical filter stacked with the diffraction element. The optical filter is configured to forwardly deflect a light from a real-world environment incident onto the optical filter, at an incidence angle greater than or equal to a predetermined angle, toward the diffraction element. The diffraction element is configured to transmit the light forwardly deflected by the optical filter.

In some embodiments, the diffraction element is configured to substantially diffract the second light transmitted through the optical filter. In some embodiments, the optical filter includes a transmissive PVH element. In some embodiments, the diffraction element includes one of a transmissive PVH element and a reflective PVH element.

In accordance with an embodiment of the present disclosure, a device is provided. The device includes a polarization hologram having a first surface and a second surface. The device also includes a retardation film having a third surface and a fourth surface. The device further includes a substrate disposed between the polarization hologram and the retardation film. The polarization hologram is configured to refract a first light incident onto the first surface toward the substate and the retardation film, the first light propagating through the substate into the retardation film from the third surface. The retardation film is configured to reflect the first light at the fourth surface as a second light propagating toward the third surface, and convert the second light into a third light having a predetermined polarization while transmitting the second light, the third light propagating through the substrate into the polarization hologram from the second surface. The polarization hologram is configured to transmit the third light out of the polarization hologram from the first surface.

In some embodiments, the polarization hologram is configured to substantially diffract a circularly polarized light having a first handedness, and substantially transmit a circularly polarized light having a second handedness opposite to the first handedness, and the third light having the predetermined polarization is a circularly polarized light having the second handedness.

In some embodiments, the second light is a substantially s-polarized light. In some embodiments, an incidence angle of the first light at the fourth surface of the retardation film is within a range of 25° to 40°. In some embodiments, the retardation film includes at least one of an A-film, an O-film, or a biaxial film.

In accordance with an embodiment of the present disclosure, a device is provided. The device includes a substrate, a polarization hologram disposed at a first surface of the substrate, and a retardation film disposed at a second surface of the substate opposing to the first surface. The polarization hologram is configured to substantially diffract a light when the light has a first handedness and substantially transmit the light when the light has a second handedness opposite to the first handedness. The polarization hologram is configured to refract a first light from a real-world environment toward the second surface of the substate. The retardation film is configured to convert the first light into a second light having the second handedness when the first light is reflected by the second surface of the substate. The polarization hologram is configured to transmit the second light having the second handedness.

In accordance with an embodiment of the present disclosure, an optical element is provided. The optical element includes a birefringent medium layer having an optic axis configured with respective spatially varying orientations in both of an in-plane direction and an out-of-plane direction. The birefringent medium layer includes optically anisotropic molecules, orientations of directors of the optically anisotropic molecules spatially varying in the out-of-plane direction. A vertical pitch of the birefringent medium layer varies in the out-of-plane direction, the vertical pitch being a distance along the out-of-plane direction over which the orientations of directors of the optically anisotropic molecules vary by a predetermined angle.

In some embodiments, the out-of-plane direction is a thickness direction of the birefringent medium layer. In some embodiments, the predetermined angle is 180 degrees. In some embodiments, the birefringent medium layer includes a PVH film having a birefringence that is equal to or less than a predetermined value. In some embodiments, the predetermined value is 0.2. In some embodiments, the predetermined value is 0.1. In some embodiments, the optical element is a single layer PVH element, and the birefringent medium layer includes a single PVH film configured with the vertical pitch varying in the out-of-plane direction. In some embodiments, the optical element is a multi-layer PVH element, and the birefringent medium layer includes two PVH films configured with different vertical pitches. In some embodiments, the optical element is a multi-layer PVH element, and the birefringent medium layer includes a first PVH film configured with the vertical pitch varying in the out-of-plane direction and a second PVH film configured with a constant vertical pitch.

Further, when an embodiment illustrated in a drawing shows a single element, it is understood that the embodiment or another embodiment not shown in the figures but within the scope of the present disclosure may include a plurality of such elements. Likewise, when an embodiment illustrated in a drawing shows a plurality of such elements, it is understood that the embodiment or another embodiment not shown in the figures but within the scope of the present disclosure may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one figure/embodiment but not shown in another figure/embodiment may nevertheless be included in the other figure/embodiment. In any optical device disclosed herein including one or more optical layers, films, plates, or elements, the numbers of the layers, films, plates, or elements shown in the figures are for illustrative purposes only. In other embodiments not shown in the figures, which are still within the scope of the present disclosure, the same or different layers, films, plates, or elements shown in the same or different figures/embodiments may be combined or repeated in various manners to form a stack.

Various embodiments have been described to illustrate the exemplary implementations. Based on the disclosed embodiments, a person having ordinary skills in the art may make various other changes, modifications, rearrangements, and substitutions without departing from the scope of the present disclosure. Thus, while the present disclosure has been described in detail with reference to the above embodiments, the present disclosure is not limited to the above described embodiments. The present disclosure may be embodied in other equivalent forms without departing from the scope of the present disclosure. The scope of the present disclosure is defined in the appended claims.

What is claimed is:

1. A device, comprising:
a diffraction element; and
an optical filter stacked with the diffraction element and configured to:
forwardly deflect a light from a real-world environment incident onto the optical filter, at an incidence angle greater than or equal to a predetermined angle, toward the diffraction element,
wherein the diffraction element is configured to substantially transmit the light forwardly deflected by the optical filter.

2. The device of claim 1, wherein the light from the real-world environment incident onto the optical filter at the incidence angle greater than or equal to the predetermined angle is a first light having a first incidence angle, the optical filter is configured to:
transmit a second light from the real-world environment incident onto the optical filter at a second incidence angle less than the predetermined angle toward the diffraction element.

3. The device of claim 2, wherein the diffraction element is configured to substantially diffract the second light transmitted through the optical filter.

4. The device of claim 1, wherein the optical filter includes a transmissive polarization volume hologram (“PVH”) element.

5. The device of claim 1, wherein the diffraction element includes one of a transmissive PVH element and a reflective PVH element.

6. A device, comprising:
a polarization hologram having a first surface and a second surface;
a retardation film having a third surface and a fourth surface; and
a substrate disposed between the polarization hologram and the retardation film,
wherein the polarization hologram is configured to refract a first light incident onto the first surface toward the substate and the retardation film, the first light propagating through the substate into the retardation film from the third surface,
wherein the retardation film is configured to reflect the first light at the fourth surface as a second light propagating toward the third surface, and convert the second light into a third light having a predetermined polarization while transmitting the second light, the third light propagating through the substrate into the polarization hologram from the second surface, and
wherein the polarization hologram is configured to transmit the third light out of the polarization hologram from the first surface.

7. The device of claim 6, wherein the polarization hologram is configured to substantially diffract a circularly polarized light having a first handedness, and substantially transmit a circularly polarized light having a second handedness opposite to the first handedness, and the third light having the predetermined polarization is a circularly polarized light having the second handedness.

8. The device of claim 6, wherein the second light is a substantially s-polarized light.

9. The device of claim 6, wherein an incidence angle of the first light at the fourth surface of the retardation film is within a range of 25° to 40°.

10. The device of claim 6, wherein the retardation film includes at least one of an A-film, an O-film, or a biaxial film.

11. An optical element, comprising:
a birefringent medium layer having an optic axis configured with respective spatially varying orientations in both of an in-plane direction and an out-of-plane direction,
wherein the birefringent medium layer includes optically anisotropic molecules, orientations of directors of the optically anisotropic molecules spatially varying in the out-of-plane direction, and
wherein a vertical pitch of the birefringent medium layer varies in the out-of-plane direction, the vertical pitch being a distance along the out-of-plane direction over which the orientations of the directors of the optically anisotropic molecules vary by a predetermined angle.

12. The optical element of claim 11, wherein the out-of-plane direction is a thickness direction of the birefringent medium layer.

13. The optical element of claim 11, wherein the predetermined angle is 180 degrees.

14. The optical element of claim 11, wherein the birefringent medium layer includes a PVH film configured with a birefringence that is equal to or less than a predetermined value.

15. The optical element of claim 14, wherein the predetermined value is 0.2.

16. The optical element of claim 14, wherein the predetermined value is 0.1.

17. The optical element of claim 11, wherein the optical element is a single layer PVH element, and the birefringent medium layer includes a single PVH film configured with the vertical pitch varying in the out-of-plane direction.

18. The optical element of claim 11, wherein the optical element is a multi-layer PVH element, and the birefringent medium layer includes two PVH films configured with different vertical pitches.

19. The optical element of claim 11, wherein the optical element is a multi-layer PVH element, and the birefringent medium layer includes a first PVH film configured with the vertical pitch varying in the out-of-plane direction and a second PVH film configured with a constant vertical pitch.
